(19) United States
(12) Patent Application Publication
(10) Pub. No.: US 2026/0277978 A1
(43) Pub. Date: Sep. 17, 2026

(54) VIRTUAL ASSISTANT AND VOICE INTEGRATION FOR POWER MACHINES

(71) Applicant: Doosan Bobcat North America, Inc., West Fargo, ND (US)

(72) Inventors: Philip Hoffert, Bismarck, ND (US); Chad Swenson, Bismarck, ND (US); Scott Johnson, Horace, ND (US); Jeff Dahl, Bismarck, ND (US); Justin Jee, Fargo, ND (US); Joel Johnson, New Hope, MN (US)

(21) Appl. No.: 19/465,818

(22) Filed: Jan. 30, 2026

Related U.S. Application Data
(60) Provisional application No. 63/868,174, filed on Aug. 21, 2025.
(60) Provisional application No. 63/762,499, filed on Feb. 24, 2025.

(51) Int. Cl. G06F 16/338; E02F 3/34; E02F 9/20; E02F 9/26; G06F 16/332; G06F 16/334; G10L 15/22

(52) U.S. Cl. CPC G06F 16/338; E02F 3/34; E02F 9/2058; E02F 9/268; G06F 16/332; G06F 16/334; G10L 15/22; G10L 2015/223

(57) ABSTRACT

A virtual assistant and voice-commands may be implemented to control power machines. Additionally, on-site training or assessment functionality may be implemented with respect to power machines such that an operator’s capabilities in operating power machines may be determined.

### CROSS-REFERENCE TO RELATED APPLICATIONS

This application claims priority to U.S. Provisional Application No. 63/762,499, filed Feb. 24, 2025, and U.S. Provisional Application No. 63/868,174, filed Aug. 21, 2025, the entire contents of which are incorporated herein by reference.

### BACKGROUND

This disclosure is directed toward power machines. Power machines, for the purposes of this disclosure, include any type of machine that generates power for the purpose of accomplishing a particular task or a variety of tasks. One type of power machine is a work vehicle. Work vehicles, such as loaders, are generally self-propelled vehicles that have a work device, such as a lift arm (although some work vehicles can have other work devices) that can be manipulated to perform a work function. Work vehicles include loaders (including mini-loaders), excavators, utility vehicles, tractors (including compact tractors), and trenchers, to name a few examples.

The discussion above is merely provided for general background information and is not intended to be used as an aid in determining the scope of the claimed subject matter.

### SUMMARY OF THE DISCLOSURE

Some configurations of the disclosure are directed to implementing a virtual assistant or voice integration to control power machines. Configurations described herein can thus facilitate implementation of a virtual assistant or voice integration (e.g., voice-commands) for a power machine. Accordingly, the technology disclosed herein may provide an advantageous control schemes that enables virtual assistant implementation or voice integration on a power machine.

Some configurations of the disclosure may provide a power machine. The power machine may include a power machine frame. The power machine may include a plurality of actuators supported by the power machine frame, where the plurality of actuators may include a first actuator and a second actuator. The power machine may include a lift arm structure. The lift arm structure may include a lift arm that may be coupled to the power machine frame and that may be configured to be moved relative to the power machine frame by the first actuator. The lift arm structure may include a work element that may be supported by the lift arm and that may be configured to be moved relative to the lift arm by the second actuator. The power machine may include a control system. The control system may include one or more electronic processors in communication with the plurality of actuators. The one or more electronic processors may be configured to receive, using a microphone of the power machine, an audio input signal from an operator of the power machine, where the audio input signal may be a query related to a machine status code of the power machine. The one or more electronic processors may be configured to transform the audio input signal into a prompt. The one or more electronic processors may be configured to retrieve data related to the prompt, the data may include predetermined machine information specific to the machine status code of the power machine. The one or more electronic processors may be configured to provide the data to a large language model (LLM), where the LLM may generate a response to the query based on the prompt and the data. The one or more electronic processors may be configured to control the power machine to output the response to the operator of the power machine, where the response may be responsive to the query.

Some configurations of the disclosure may provide a power machine. The power machine may include a power machine frame. The power machine may include a plurality of actuators supported by the power machine frame, where the plurality of actuators may include a first actuator and a second actuator. The power machine may include a lift arm structure. The lift arm structure may include a lift arm that may be coupled to the power machine frame and that may be configured to be moved relative to the power machine frame by the first actuator. The lift arm structure may include a work element that may be supported by the lift arm and that may be configured to be moved relative to the lift arm by the second actuator. The power machine may include a control system. The control system may include one or more electronic processors in communication with the plurality of actuators. The one or more electronic processors may be configured to receive, using a microphone of the power machine, an audio input signal from an operator of the power machine, the audio input signal may represent a query relating to maintenance of the power machine. The one or more electronic processors may be configured to transform the audio input signal into a prompt. The one or more electronic processors may be configured to retrieve data related to the prompt, where the data may include machine information. The one or more electronic processors may be configured to provide the retrieved data to a large language model (LLM), where the LLM may generate a response to the query based on the prompt and the retrieved data. The one or more electronic processors may be configured to control the power machine to output the response to the operator of the power machine, responsive to the query.

Some configurations of the disclosure may provide a power machine. The power machine may include a power machine frame. The power machine may include a plurality of actuators supported by the power machine frame, where the plurality of actuators may include a first actuator and a second actuator. The power machine may include a lift arm structure. The lift arm structure may include a lift arm that may be coupled to the power machine frame and that may be configured to be moved relative to the power machine frame by the first actuator. The lift arm structure may include a work element that may be supported by the lift arm and that may be configured to be moved relative to the lift arm by the second actuator. The power machine may include a control system. The control system may include one or more electronic processors in communication with the plurality of actuators. The one or more electronic processors may be configured to receive, using a microphone of the power machine, an audio input signal from an operator of the power machine, the audio input signal may include a user query relating to the power machine. The one or more electronic processors may be configured to transform the audio input signal into a prompt. The one or more electronic processors may be configured to retrieve data related to the prompt. The one or more electronic processors may be configured to provide the retrieved data to a large language model (LLM), where the LLM may generate a response to the user query based on the prompt and the retrieved data. The one or more electronic processors may be configured to control the power machine to output the response to the operator of the power machine.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of examples of the disclosure and are not intended to limit the scope of the disclosure or exclude alternative implementations.

FIG. 1 is a block diagram illustrating functional systems of a representative power machine on which configurations of the present disclosure can be advantageously practiced.

FIG. 2 is a perspective view showing generally a front of a power machine on which configurations disclosed in this specification can be advantageously practiced.

FIG. 3 is a perspective view showing generally a back of the power machine shown in FIG. 2.

FIG. 4 is a block diagram illustrating components of a power system of the loader of FIGS. 2 and 3 or other power machines.

FIG. 5 is a side elevation view showing certain components of a power machine in the form of an electrically powered compact tracked loader according to configurations of the disclosure.

FIG. 6 is a block diagram of a power machine according to some configurations.

FIG. 7 schematically illustrates a controller of the power machine of FIG. 6 according to some configurations.

FIG. 8 is a flowchart illustrating a method for implementing voice-commands for controlling a power machine according to some configurations.

FIG. 9 is a flowchart illustrating a method for implementing assessment functionality for a power machine according to some configurations.

FIG. 10 is a flowchart illustrating a method for implementing training functionality for a power machine according to some configurations.

FIG. 11 illustrates a table that includes example features that may be implemented according to configurations of the disclosure (e.g., using voice-commands).

### DETAILED DESCRIPTION OF THE PRESENT DISCLOSURE

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items. In addition, any feature disclosed with respect to one embodiment may be included in another embodiment, and vice-versa.

While the power machines disclosed herein may be embodied in many different forms, several specific embodiments are discussed herein with the understanding that the embodiments described in the present disclosure are to be considered only exemplifications of the principles described herein, and the technology disclosed herein is not intended to be limited to the embodiments illustrated.

Some discussion below describes improved components and configurations for power machines, including components and configurations that use electrical (e.g., as opposed to hydraulic) power to operate certain power machine components or otherwise implement certain power machine functionality. In some configurations, electrically powered components can be mounted to a frame of a power machine to selectively move work elements of the power machine, including lift arms or implement carriers. In some configurations, electrically powered components can provide motive power for a power machine, including for tracked power machines (e.g., compact tracked loaders).

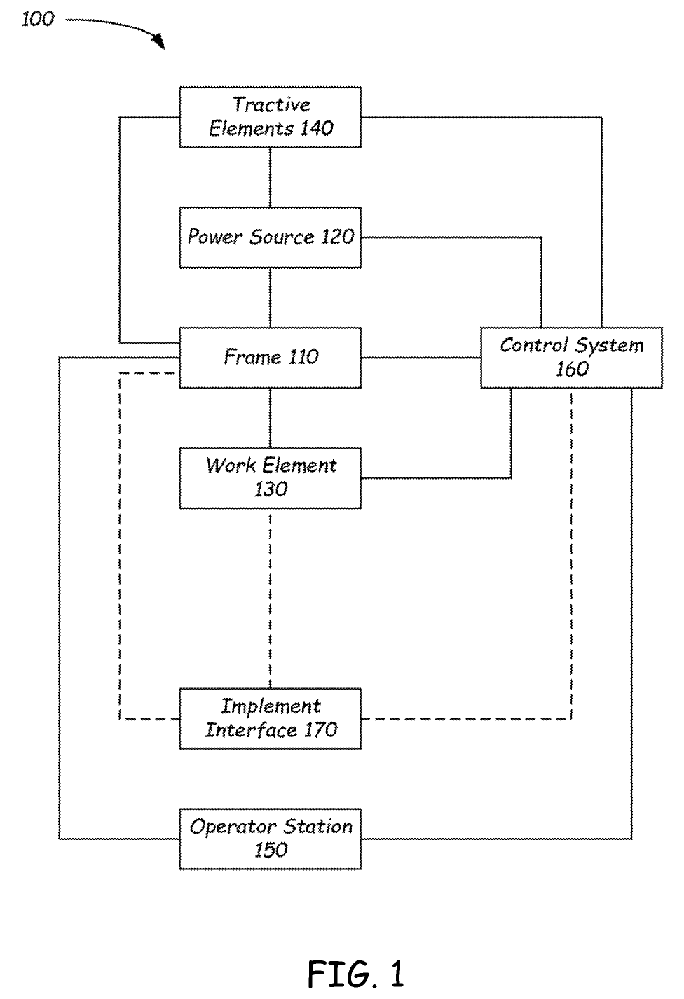

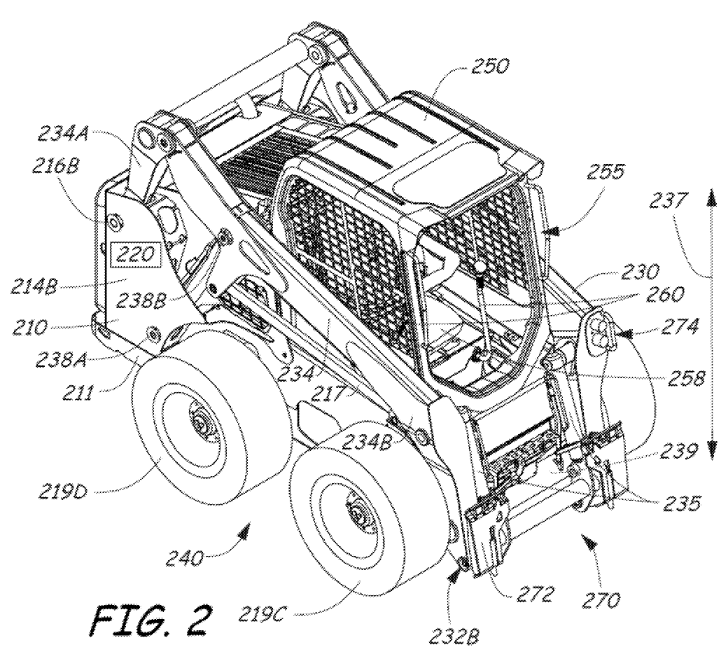

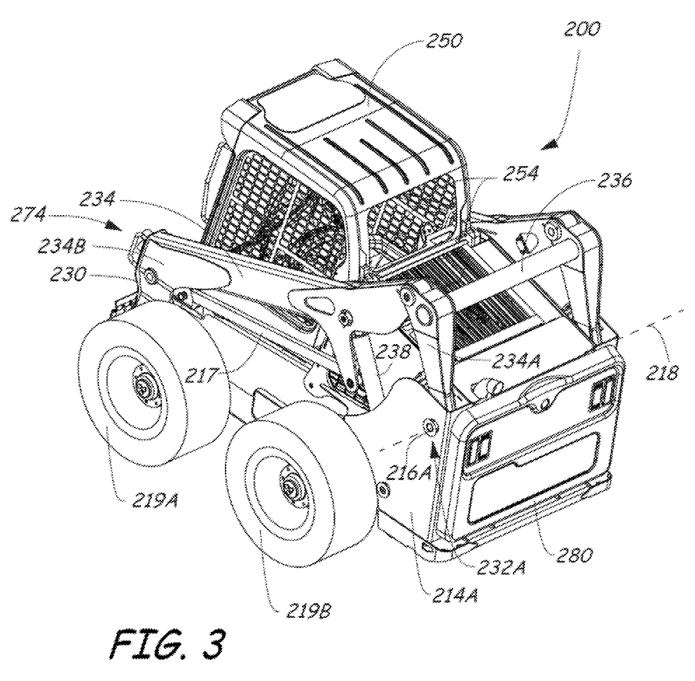

These concepts can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is illustrated and discussed as being a representative power machine. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 is a block diagram that illustrates the basic systems of a power machine 100, which can be any of a number of different types of power machines, upon which the embodiments discussed below can be advantageously incorporated. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm to which an implement such as a bucket is attached such as by a pinning arrangement. The work element, i.e., the lift arm can be manipulated to position the implement to perform the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of different implements to the work element. One characteristic of such an implement carrier is that once an implement is attached to it, it is fixed to the implement (i.e., not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is configured to provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electric sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. For example, the power machine can be a mower with a mower deck or other mower component as a work element, which may be movable with respect to the frame of the mower. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that is capable of controlling at least some of the operator-controlled functions on the power machine.

FIGS. 2-3 illustrate a loader 200, which is one particular example of a power machine of the type illustrated in FIG. 1 where the embodiments discussed below can be advantageously employed. Loader 200 is a skid-steer loader, which is a loader that has tractive elements (in this case, four wheels) that are mounted to the frame of the loader via rigid axles. Here the phrase “rigid axles” refers to the fact that the skid-steer loader 200 does not have any tractive elements that can be rotated or steered to help the loader accomplish a turn. Instead, a skid-steer loader has a drive system that independently powers one or more tractive elements on each side of the loader so that by providing differing tractive signals to each side, the machine will tend to skid over a support surface. These varying signals can even include powering tractive element(s) on one side of the loader to move the loader in a forward direction and powering tractive element(s) on another side of the loader to mode the loader in a reverse direction so that the loader will turn about a radius centered within the footprint of the loader itself. The term “skid-steer” has traditionally referred to loaders that have skid steering as described above with wheels as tractive elements. However, it should be noted that many track loaders also accomplish turns via skidding and are technically skid-steer loaders, even though they do not have wheels. For the purposes of this discussion, unless noted otherwise, the term skid-steer should not be seen as limiting the scope of the discussion to those loaders with wheels as tractive elements. Correspondingly, although some example power machines discussed herein are presented as skid-steer power machines, some embodiments disclosed herein can be implemented on a variety of other power machines. For example, some embodiments can be implemented on compact loaders or compact excavators that do not accomplish turns via skidding.

Loader 200 is one particular example of the power machine 100 illustrated broadly in FIG. 1 and discussed above. To that end, features of loader 200 described below include reference numbers that are generally similar to those used in FIG. 1. For example, loader 200 is described as having a frame 210, just as power machine 100 has a frame 110. Skid-steer loader 200 is described herein to provide a reference for understanding one environment on which the embodiments described below related to track assemblies and mounting elements for mounting the track assemblies to a power machine may be practiced. The loader 200 should not be considered limiting especially as to the description of features that loader 200 may have described herein that are not essential to the disclosed embodiments and thus may or may not be included in power machines other than loader 200 upon which the embodiments disclosed below may be advantageously practiced. Unless specifically noted otherwise, embodiments disclosed below can be practiced on a variety of power machines, with the loader 200 being only one of those power machines. For example, some or all of the concepts discussed below can be practiced on many other types of work vehicles such as various other loaders, excavators, trenchers, and dozers, to name but a few examples.

Loader 200 includes frame 210 that supports a power system 220, the power system being capable of generating or otherwise providing power for operating various functions on the power machine. Power system 220 is shown in block diagram form but is located within the frame 210. Frame 210 also supports a work element in the form of a lift arm assembly 230 that is powered by the power system 220 and that can perform various work tasks. As loader 200 is a work vehicle, frame 210 also supports a traction system 240, which is also powered by power system 220 and can propel the power machine over a support surface. The lift arm assembly 230 in turn supports an implement interface 270, which includes an implement carrier 272 that can receive and secure various implements to the loader 200 for performing various work tasks and power couplers 274, to which an implement can be coupled for selectively providing power to an implement that might be connected to the loader. Power couplers 274 can provide sources of hydraulic or electric power or both. The loader 200 includes a cab 250 that defines an operator station 255 from which an operator can manipulate various control devices 260 to cause the power machine to perform various work functions. Cab 250 can be pivoted back about an axis that extends through mounts 254 to provide access to power system components as needed for maintenance and repair.

The operator station 255 includes an operator seat 258 and a plurality of operation input devices, including control levers 260 that an operator can manipulate to control various machine functions. Operator input devices can include buttons, switches, levers, sliders, pedals and the like that can be stand-alone devices such as hand operated levers or foot pedals or incorporated into hand grips or display panels, including programmable input devices. Actuation of operator input devices can generate signals in the form of electric signals, hydraulic signals, and/or mechanical signals. Signals generated in response to operator input devices are provided to various components on the power machine for controlling various functions on the power machine. Among the functions that are controlled via operator input devices on power machine 200 include control of the tractive elements 219, the lift arm assembly 230, the implement carrier 272, and providing signals to any implement that may be operably coupled to the implement.

Loaders can include human-machine interfaces including display devices that are provided in the cab 250 to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such walk behind loaders may not have a cab nor an operator compartment, nor a seat. The operator position on such loaders is generally defined relative to a position where an operator is best suited to manipulate operator input devices.

Various power machines that can include and/or interacting with the embodiments discussed herein can have various different frame components that support various work elements. The elements of frame 210 discussed herein are provided for illustrative purposes and frame 210 is not the only type of frame that a power machine on which the embodiments can be practiced can employ. Frame 210 of loader 200 includes an undercarriage or lower portion 211 of the frame and a mainframe or upper portion 212 of the frame that is supported by the undercarriage. The mainframe 212 of loader 200, in some embodiments is attached to the undercarriage 211 such as with fasteners or by welding the undercarriage to the mainframe. Alternatively, the mainframe and undercarriage can be integrally formed. Mainframe 212 includes a pair of upright portions 214A and 214B located on either side and toward the rear of the mainframe that support lift arm assembly 230 and to which the lift arm assembly 230 is pivotally attached. The lift arm assembly 230 is illustratively pinned to each of the upright portions 214A and 214B. The combination of mounting features on the upright portions 214A and 214B and the lift arm assembly 230 and mounting hardware (including pins used to pin the lift arm assembly to the mainframe 212) are collectively referred to as joints 216A and 216B (one is located on each of the upright portions 214) for the purposes of this discussion. Joints 216A and 216B are aligned along an axis 218 so that the lift arm assembly is capable of pivoting, as discussed below, with respect to the frame 210 about axis 218. Other power machines may not include upright portions on either side of the frame or may not have a lift arm assembly that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements in the form of wheels 219A-D on either side of the loader 200.

The lift arm assembly 230 shown in FIGS. 2-3 is one example of many different types of lift arm assemblies that can be attached to a power machine such as loader 200 or other power machines on which embodiments of the present discussion can be practiced. The lift arm assembly 230 is what is known as a vertical lift arm, meaning that the lift arm assembly 230 is moveable (i.e., the lift arm assembly can be raised and lowered) under control of the loader 200 with respect to the frame 210 along a lift path 237 that forms a generally vertical path along which the lift arm assembly can be raised or lowered. Other lift arm assemblies can have different geometries and can be coupled to the frame of a loader in various ways to provide lift paths that differ from the radial path of lift arm assembly 230. For example, some lift paths on other loaders provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

The lift arm assembly 230 has a pair of lift arms 234 that are disposed on opposing sides of the frame 210. A first end 232A of each of the lift arms 234 is pivotally coupled to the power machine at joints 216 and a second end 232B of each of the lift arms is positioned forward of the frame 210 when in a lowered position as shown in FIG. 2. Joints 216 are located toward a rear of the loader 200 so that the lift arms extend along the sides of the frame 210. The lift path 237 is defined by the path of travel of the second end 232B of the lift arms 234 as the lift arm assembly 230 is moved between a minimum and maximum height.

Each of the lift arms 234 has a first portion 234A of each lift arm 234 is pivotally coupled to the frame 210 at one of the joints 216 and the second portion 234B extends from its connection to the first portion 234A to the second end 232B of the lift arm assembly 230. The lift arms 234 are each coupled to a cross member 236 that is attached to the first portions 234A. Cross member 236 provides increased structural stability to the lift arm assembly 230. A pair of actuators 238, which on loader 200 are hydraulic cylinders configured to receive pressurized fluid from power system 220, are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm assembly 230 to pivot about joints 216 and thereby be raised and lowered along a fixed path illustrated by arrow 237. Each of a pair of control links 217 are pivotally mounted to the frame 210 and one of the lift arms 232 on either side of the frame 210. The control links 217 help to define the fixed lift path of the lift arm assembly 230.

Some lift arms, most notably lift arms on excavators but also possible on loaders, may have portions that are controllable to pivot with respect to another segment instead of moving in concert (i.e., along a pre-determined path) as is the case in the lift arm assembly 230 shown in FIG. 2. Some power machines have lift arm assemblies with a single lift arm, such as is known in excavators or even some loaders and other power machines. Other power machines can have a plurality of lift arm assemblies, each being independent of the other(s).

An implement interface 270 is provided proximal to a second end 232B of the lift arm assembly 230. The implement interface 270 includes an implement carrier 272 that is capable of accepting and securing a variety of different implements to the lift arm 234. Such implements have a complementary machine interface that is configured to be engaged with the implement carrier 272. The implement carrier 272 is pivotally mounted at the second end 232B of the arm 234. Implement carrier actuators 235 are operably coupled the lift arm assembly 230 and the implement carrier 272 and are operable to rotate the implement carrier with respect to the lift arm assembly. Implement carrier actuators 235 are illustratively hydraulic cylinders and often known as tilt cylinders.

By having an implement carrier capable of being attached to a plurality of different implements, changing from one implement to another can be accomplished with relative ease. For example, machines with implement carriers can provide an actuator between the implement carrier and the lift arm assembly, so that removing or attaching an implement does not involve removing or attaching an actuator from the implement or removing or attaching the implement from the lift arm assembly. The implement carrier 272 provides a mounting structure for easily attaching an implement to the lift arm (or other portion of a power machine) that a lift arm assembly without an implement carrier does not have.

Some power machines can have implements or implement like devices attached to it such as by being pinned to a lift arm with a tilt actuator also coupled directly to the implement or implement type structure. A common example of such an implement that is rotatably pinned to a lift arm is a bucket, with one or more tilt cylinders being attached to a bracket that is fixed directly onto the bucket such as by welding or with fasteners. Such a power machine does not have an implement carrier, but rather has a direct connection between a lift arm and an implement.

The implement interface 270 also includes power coupler(s) 274 available for connection to an implement on the lift arm assembly 230. The power coupler(s) 274 includes pressurized hydraulic fluid port to which an implement can be removably coupled. The pressurized hydraulic fluid port selectively provides pressurized hydraulic fluid for powering one or more functions or actuators on an implement. The power coupler can also include an electric power source for powering electric actuators and/or an electronic controller on an implement. The power coupler(s) 274 also exemplarily includes electric conduits that are in communication with a data bus on the excavator 200 to allow communication between a controller on an implement and electronic devices on the loader 200.

Frame 210 supports and generally encloses the power system 220 so that the various components of the power system 220 are not visible in FIGS. 2-3. The arrangement of drive pumps, motors, and axles in power machine 200 is but one example of an arrangement of these components. As discussed above, power machine 200 is a skid-steer loader and thus tractive elements on each side of the power machine are controlled together via the output of a single hydraulic pump, either through a single drive motor as in power machine 200 or with individual drive motors. Various other configurations and combinations of hydraulic drive pumps and motors can be employed as may be advantageous.

The description of power machine 100 and loader 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on a loader such as track loader 200, unless otherwise noted or recited, the concepts discussed below are not intended to be limited in their application to the environments specifically described above.

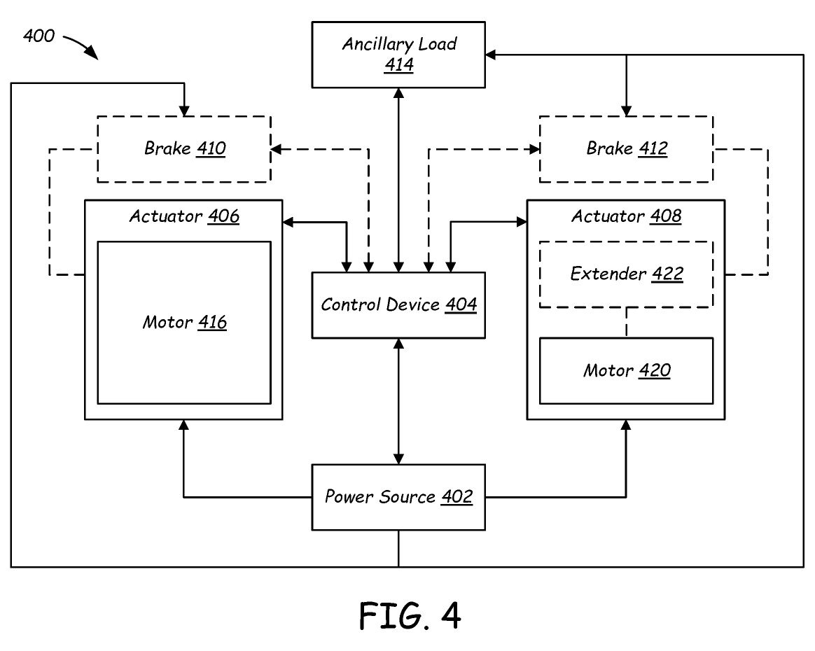

FIG. 4 shows a schematic illustration of a block diagram of a power machine 400, which can be any of a number of different types of power machines (e.g., wheeled or tracked skid-steer loaders), including any of the types generally discussed herein. To accomplish various work and drive operations, the power machine 400 can include a power source 402, a control device 404, and electric actuators 406, 408. Either or both of the electric actuators 406, 408 can be variously configured as one or more drive actuators, or one or more workgroup actuators, and a different number of individual actuators can be provided than is generally shown in FIG. 4. For example, as further discussed below, some power machines can include a left-side and right-side drive actuators, each including a respective electronic drive motor disposed to power an associate tractive element (e.g., an endless track assembly), as well as various extendable (or other) work actuators (e.g., one or more extendable lift arm actuators, one or more extendable tilt actuators, etc.). In some cases, as also shown in FIG. 4, one or more brakes 410, 412 can be configured to stop movement of an associated one or more of the actuators 406, 408, including based on control signals from the control device 404.

In the illustrated example, the power machine 400 can be an electrically powered power machine and thus the power source 402 can include an electric power source such as, for example, a battery pack that includes one or more battery cells (e.g., lithium-ion batteries). In some embodiments, the power source 402 can include other electric storage devices (e.g., a capacitor), and other power sources. In addition, the power machine 400 can, but need not, include an internal combustion engine that provides, via a generator, electric power to the power source 402 (e.g., to charge one or more batteries of the electric power source).

Generally, the control device 404 can be implemented in a variety of different ways and can include one or more types or instances of known electronic controllers. For example, the control device 404 can be implemented as known types of processor devices, (e.g., microcontrollers, field-programmable gate arrays, programmable logic controllers, logic gates, etc.), including as part of one or more general or special purpose computers. In addition, the control device 404 can also include or be in operative communication with other computing components, including memory, inputs, output devices, etc. (not shown). In this regard, the control device 404 can be configured to implement some or all of the operations of the processes described herein, which can, as appropriate, be retrieved from or otherwise interact with memory. In some embodiments, the control device 404 can include multiple control devices (or modules) that can be integrated into a single component or arranged as multiple separate components. In some embodiments, the control device 404 can be part of a larger control system (e.g., the control system 160 of FIG. 1) and can accordingly include or be in electronic communication with a variety of control modules, including hub controllers, engine controllers, drive controllers, and so on.

In different embodiments, different types of actuators can be configured to operate under power from the power source 402, including electric actuators configured as rotary actuators, linear actuators, and combinations thereof. In the example shown in FIG. 4, the actuator 406 is a drive actuator and includes an electric motor 416 that is configured to provide rotational power to one or more tractive elements (not shown in FIG. 4). As noted above, some power machines can include multiple drive actuators, including as can be arranged for skid-steer operation.

Also as shown in the example of FIG. 4, the actuator 408 is a workgroup actuator and thus includes an electric motor 420 that is configured to provide rotational power for operation of one or more non-drive work elements (e.g., a lift arm, an implement, etc.). In some cases, the motor 420 can be configured to power movement of an extender 422 (e.g., a lead screw, a ball screw, another similar threaded assembly, or other known components for rotationally powered non-rotational movement), which can convert rotational power of the motor 420 into translational movement of the extender 422 so as to provide translational power to a work element of the power machine 400. For example, the motor 420 can rotate in a first direction to drive extension of the extender 422 and can rotate in a second direction to drive retraction of the extender 422 when the motor rotates in a second rotational direction opposite the first rotational direction. In this way, and depending on how the electric actuator 406 is coupled to the components of the power machine 400, extension (and retraction) of the electric actuator 406 can, for example, raise (or lower) a lift arm of the power machine 400, change an attitude an implement of the power machine 400 (e.g., a bucket), etc.

Thus, generally, each motor 416, 420 can be controlled to implement particular functionality for the power machine 400. As generally noted above, different configurations of multiple drive or workgroup actuators can be included in some cases (e.g., multiple instances of the actuators 406, 408 as shown), to provide different functionality for a particular power machine. For example, in some configurations, the power machine 400 can include an electric actuator that is a first lift actuator on a first lateral side of the power machine 400, an electric actuator that is a second lift actuator on a second lateral side of the power machine 400, an electric actuator that is a first tilt actuator that is on a first lateral side of the implement interface of the power machine 400, an electric actuator that is a second tilt actuator that is on a second lateral side of the implement interface of the power machine 400, an electric actuator that is a first drive actuator for a first drive system that is on (or otherwise powers one or more tractive elements for) the first lateral side of the power machine 400, and an electric actuator that is a second drive actuator for a second drive system that is on (or otherwise powers one or more tractive elements for) the second lateral side of the power machine 400.

As also noted above, the brakes 410, 412 can be coupled to (e.g., included in) the respective electric actuators 406, 408 in some embodiments. In this regard, a wide variety of known brake systems can be used. For example, one or more brakes can be a mechanical brake that includes a mechanical stop that can be moved into engagement to block movement of a relevant extender or relevant motor, in one or more directions, and can be moved out of engagement to allow movement of the relevant extender or motor. In some cases, a mechanical brake can include an arm that contacts a lead screw of an extender to block further movement of the lead screw. In some embodiments, one or more electrically powered brakes can be provided (i.e., brake assemblies that include one or more electric actuators for application of braking force).

As shown in FIG. 4, the power source 402 can be electrically connected to the control device 404, the electric actuators 406, 408, and the brakes 410, 412 (as appropriate), as well as one or more ancillary loads 414. Thus, the power source 402 can provide power to each motor 416, 420 to drive movement (e.g., extension and retraction) of the respective extenders 418, 422, to the control device 404, to each brake 410, 412 (as appropriate), to each of the ancillary load(s) 414, etc. Further, the power source 402 can provide power to the ancillary loads 414 (i.e., loads not associated with providing tractive or workgroup power) for various ancillary functionality. For example, ancillary loads 414 can include a climate control system (e.g., including a heater, an air-conditioning system, a fan, etc.), a sound system (e.g., a speaker, a radio, etc.), etc. In some cases, ancillary loads 414 may be treated with lower priority according to certain power management modes.

As shown in FIG. 4, the control device 404 can be in electrical communication with the power source 402, the actuators 406, 408 (as appropriate), the brakes 410, 412 (as appropriate), and the ancillary load(s) 414, and can adjust (e.g., limit) the power delivered from the power source 402 to, or the power consumed by, each of these electric loads (or others). For example, as appropriate, the control device 404 can adjust (e.g., decrease) the power delivered to each of these electric loads by adjusting (e.g., decreasing) the electric current that can be consumed by at least some of these electric loads. In some cases, the control device 404 can adjust the electric current delivered to an electric load by adjusting a driving signal delivered to an electric current source (e.g., a voltage controlled electric current source) that can be electrically connected to the electric load (e.g., integrated within a power electronics driver board, such as a motor driver) to deliver electric current to the electric load. For example, the electric current source can include one or more field-effect transistors, and the driving signal can be the voltage applied to the one or more field-effect transistors to adjust the electric current delivered and thus the power delivered to the electric load (e.g., the motor).

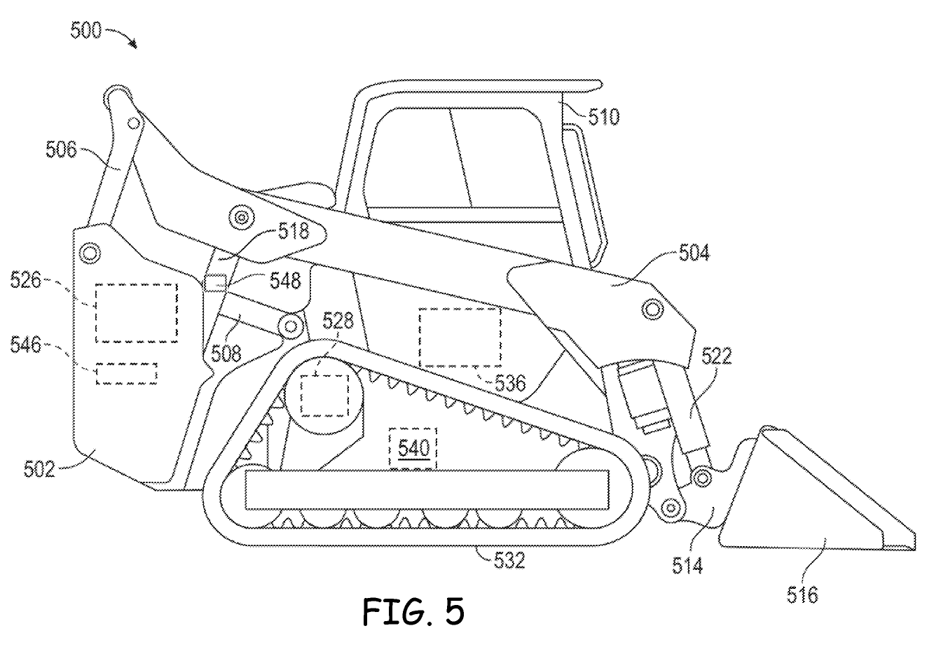

In some embodiments, the power machine 400 can include one or more sensors that can sense various aspects of the power machine 400. For example, the power machine 400 can include a torque sensor for one or more electric actuators, to sense a present torque of the one or more electric actuator. In some cases, the torque sensor can be the same as the electric current sensor electrically connected to the electric actuator (e.g., because electric current is related to the torque). As another example, the power machine 400 can include a position sensor for one or more extenders or other components of one or more electric actuators (as appropriate), including as may sense a present extension amount for an extender of an electric actuator (e.g., relative to the housing of the electric actuator). In some cases, this can be a hall-effect sensor, a rotary encoder for the motor (e.g., which can be used to determine the extension amount of actuators with extenders), an optical sensor, etc. In some cases, as shown in FIG. 5, the power machine 400 can include a resolver 548 configured to track relative movement of the actuator 518. As yet another example, the power machine 400 can include an angle sensor for one or more pivotable joints (e.g., of the lift arm) to determine a current orientation of the lift arm (and any implement coupled thereto). As yet another example, the power machine 400 can include a speed sensor or an acceleration sensor (e.g., an accelerometer) to respectively determine a current speed or a current acceleration of the entire power machine 400 or of a component thereof. As still yet another example, the power machine 400 can include an inclinometer (e.g., an accelerometer) that can sense the current attitude of a mainframe of the power machine 400 with respect to gravity.

FIG. 5 shows a side isometric view of an electrically powered power machine 500 with a lift arm in a fully lowered position, which can be a specific implementation of the power machine 200, the power machine 400, etc. As shown in FIG. 5, the power machine 500 can include a main frame 502, a lift arm 504 coupled to the main frame via a follower link 506, a driver link 508 pivotally coupled to the lift arm 504 and the main frame 502, an operator enclosure 510 (e.g., a cab, as shown), an implement interface 514 coupled to an end of the lift arm 504, an implement 516 (e.g., a bucket as shown) coupled to the implement interface 514, an electric lift actuator 518, an electric tilt actuators 522, an electric power source 526, a drive system 528 (e.g., including an electric drive motor), a traction devices 532 (e.g., an endless track, as shown), and a climate control system 536 (e.g., as generally representative of an ancillary electric load). In some embodiments, a suspension system 540 (e.g., a torsional suspension system) can be included, to provide improved ride control and overall smoothness of travel. As generally noted above, similar (e.g., substantially identical) other components can be provided symmetrically (or otherwise) on an opposing lateral side of the power machine 500 in some cases, including another electric lift actuator, another electric tilt actuator, etc.

In some cases, the electric power source 526 can be implemented in a similar manner as the previously described power sources (e.g., the power source 402). Thus, the electric power source 526 can include a battery pack including one or more batteries. In general, the electric power source 526 can supply power to some or all of the electric loads of the power machine 500. For example, the electric power source 526 can provide power to the lift electric actuator 518, the electric tilt actuator 522, the drive system 528, the climate control system 536, etc.

The power machine 500 can also include a control device 546 (e.g., a general or special purpose electronic computer or other electronic controller) that can be in communication with the power source 526 and some (or all) of the electric loads of the power machine 500, as appropriate. For example, the control device 546 can be in communication with the lift electric actuator 518, the electric tilt actuator 522, the drive system 528, the climate control system 536, etc. In this way, the control device 546 can control operation of these components, or related other systems, to adjust how power is routed to each of these electric loads (e.g., depending on the criteria defined by a particular power management mode) and, correspondingly, how these components operate under power from the power source 526.

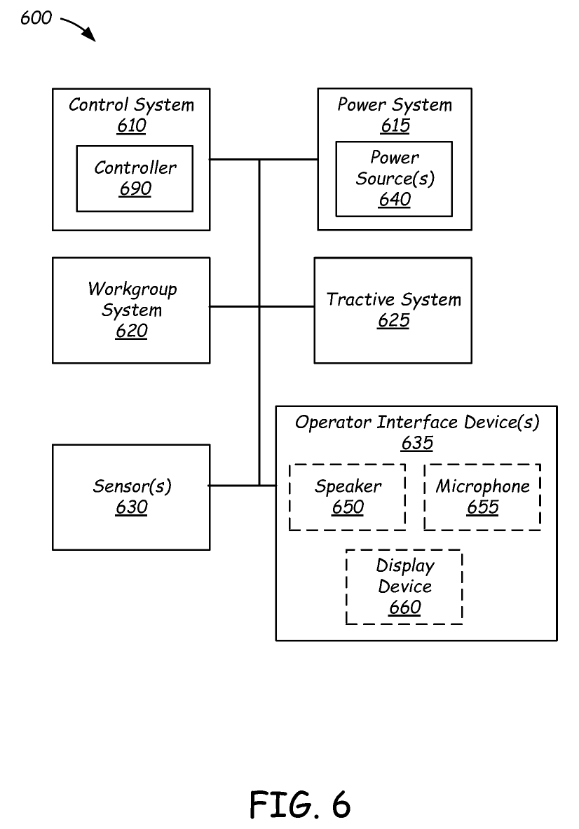

FIG. 6 schematically illustrates a power machine 600 according to some configurations. The power machine 600 can be any of a number of different types of power machines (e.g., wheeled or tracked skid-steer loaders), including any of the types generally discussed herein. In some configurations, the power machine 600 may operate in whole or in part under electrical power.

In the example illustrated in FIG. 6, the power machine 600 includes a control system 610 (e.g., the control system 160, as described herein), a power system 615, a workgroup system 620, a tractive system 625, one or more sensors 630, and one or more operator interface devices 635. The control system 610, the power system 615, the workgroup system 620, the tractive system 625, the sensor(s) 630, and the operator interface device(s) 635 communicate over one or more communication lines or buses. The power machine 600 may include additional, fewer, or different components than those illustrated in FIG. 6 in various configurations and may perform additional functionality than the functionality described herein. For example, the power machine 600 may include additional, similar, or different components, systems, and functionality as described above with respect to the power machine 100 of FIG. 1, the loader 200 of FIGS. 2-3, the power machine 400 of FIG. 4, the electric power machine 500 of FIG. 5, or another power machine described herein.

The workgroup system 620 may include one or more workgroup components as generally discussed herein, such as, e.g., one or more work elements (e.g., the work element 130 of FIG. 1, etc.), one or more implements (e.g., the implement 516 of FIG. 5, etc.), one or more actuators (e.g., the actuators 406, 408 of FIG. 4, the actuators 518, 522 of FIG. 5, etc.), and so on. The tractive system 625 may include one or more tractive related components as generally discussed herein, such as, e.g., one or more tractive elements (e.g., the tractive elements 140 of FIG. 1, the tractive elements 219 of FIG. 2, etc.), one or more drive systems (e.g., the drive system 528 of FIG. 5, etc.), one or more traction devices (e.g., the traction device 532, etc.), and so on. Generally, these noted elements can be included individually or in pluralities, and discussion herein accordingly may refer to these elements in the singular or plural for convenience.

The power machine 600 may also include the power system 615 (e.g., the power system 220 of FIGS. 2-3). In the illustrated example of FIG. 6, the power system 615 may include one or more power sources 640 (e.g., the power source 120 of FIG. 1). Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electric sources or a combination of power sources, known generally as hybrid power sources. As described herein, the power machine 600 can be an electrically powered power and thus the power system 615 (via one or more of the power sources 640) may generate or otherwise provide electric power for operating various functions on the power machine 600 (or components thereof). The power system 615 may correspondingly provide electric power to various components of the power machine 600, e.g., one or more components of the control system 610, the workgroup system 620 (including, e.g., the workgroup actuator(s)), or the like. Generally, the power source(s) 640 of the power system 615 can thus include electric power sources, e.g., a battery pack that includes one or more battery cells (e.g., lithium-ion batteries). In some configurations, the power system 615 can include other electric storage devices (e.g., a capacitor), and other power sources. Alternatively, or in addition, the power machine 600 may include an internal combustion engine that provides electrically power to the power sources 640 via a generator (e.g., to charge one or more batteries of the power system 615).

As illustrated in FIG. 6, the power machine 600 may also include the sensor(s) 630. The sensor(s) 630 may include one or more of the sensors as generally discussed herein, such as, e.g., an electric current sensor, a voltage sensor, a torque sensor, a position sensor, an image sensor, an angle sensor, an optical sensor, a speed sensor, an acceleration sensor, a tilt sensor, a load sensor, a temperature sensor, an inertial measurement unit (IMU), etc. The sensor(s) 630 may collect data related to the power machine 600, such as, e.g., operational data or parameters related to a present operation of the power machine (e.g., operational parameter(s) of the power machine 600).

The power machine 500 may also include the control system 610. The control system 610 (e.g., the control system 160 of FIG. 1, the control system 260 of FIGS. 2-3, etc.) is configured to receive operator input or other input signals (e.g., sensor data, such as speed data, electric current data, position data, tilt or orientation data, etc.) and to output commands accordingly to control operation of the power machine 600. For example, the control system 610 can communicate with other systems of the power machine 600 to perform various work tasks, including to control the workgroup actuator(s) of the workgroup system 620 or the tractive actuator(s) of the tractive system 625 for performing a work task operation (e.g., a digging operation, a roading operation, a trenching operation, etc.), or another operation of the power machine 600.

In some configurations, the control system 610 receives input from the operator interface device(s) 635, such as, e.g., a joystick, a foot pedal, etc. The operator interface device(s) 635 may include one of the operator input devices 256 of FIGS. 2-3, including input as command signals provided by an operator of the power machine 500 via the operator input device 256 (also referred to herein as “operator commands” or “commands”). As one example, an operator command may include a commanded lift for the workgroup system 620 of the power machine 600 (e.g., a change in lift position of the work element). In response to receiving the input, the control system 610 may generally control the power machine 600, particularly the relevant workgroup actuators, to perform the commanded operation.

As noted herein, in some configurations, the technology disclosed herein may implement voice integration for controlling a power machine (e.g., the power machine 600). As such, in some configurations, the operator interface device(s) 635 may include a speaker 650 and a microphone 655. As described in greater detail herein, the speaker 650 may provide an audio output signal, such as, e.g., an audible speech or voice and the microphone 655 may receive an audio input signal, such as, e.g., a voice recording of an operator of the power machine 600. In some instances, the microphone 655 may receive the audio input signal during activation of an audio input mechanism, such as, e.g., a button, a switch, etc. For instance, while the audio input mechanism is activated (e.g., pressed or switched to a predetermined position), the microphone 655 may collect audio data (e.g., a voice recording of the operator of the power machine 600), as the audio input signal.

Alternatively, or in addition, in some configurations, the operator interface device(s) 635 may include a display device 660. The display device 660 may facilitate the input and output of operator commands. For example, the display device 660 may provide (or otherwise output) visual information or data, as described in greater detail herein.

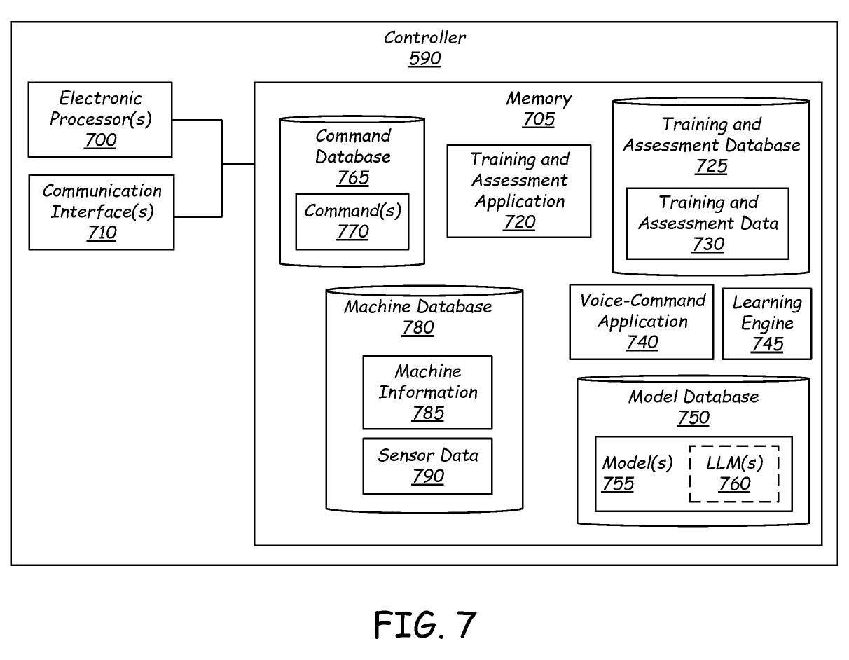

As illustrated in FIG. 6, the control system 610 includes a controller 690 (e.g., the control device 404 of FIG. 4). FIG. 7 illustrates the controller 690 according to some configurations. In the illustrated example of FIG. 7, the controller 690 includes an electronic processor 700 (for example, a microprocessor, an application-specific integrated circuit (“ASIC”), or another suitable electronic device), a memory 705 (for example, a non-transitory, computer-readable medium), and a communication interface 710. In some configurations, the electronic processor 700 may be (or otherwise include) a graphics processing unit (GPU). The electronic processor 700, the memory 705, and the communication interface 710 communicate over one or more communication lines or buses. The controller 690 may include additional components than those illustrated in FIG. 7 in various configurations and may perform additional functionality than the functionality described herein. As one example, in some embodiments, the functionality described herein as being performed by the controller 690 may be distributed among other components or devices (e.g., one or more electronic processors).

The communication interface 710 may include a port for receiving a wired connection to an external device (for example, a universal serial bus (“USB”) cable and the like), a transceiver for establishing a wireless connection to an external device (for example, over one or more communication networks, such as the Internet, local area network (“LAN”), a wide area network (“WAN”), and the like), or a combination thereof. In some configurations, the controller 690 can be a dedicated or stand-alone controller. In some configurations, the controller 690 can be part of a system of multiple distinct controllers (e.g., a hub controller, a drive controller, a workgroup controller, etc.) or can be formed by a system of multiple distinct controllers (e.g., also with hub, drive, and workgroup controllers, etc.), where the multiple distinct controllers may communicate via a controller area network (“CAN”) bus. Accordingly, in some instances, one or more components may communicate via a CAN bus. For example, in some configurations, the control system 610, the workgroup system 620, the power system 615, the tractive system 625, the sensor(s) 630, the operator interface device(s) 635, or another component of the power machine 600 may communicate via a CAN bus.

The electronic processor 700 is configured to access and execute computer-readable instructions (“software”) stored in the memory 705. The software may include firmware, one or more applications, program data, filters, rules, one or more program modules, and other executable instructions. For example, the software may include instructions and associated data for performing a set of functions, including the methods described herein.

For example, as illustrated in FIG. 7, the memory 705 may include a training and assessment application 720 (referred to herein as “the training application 720”). The training application 720 may be a software application executable by the electronic processor 700 in the example illustrated and as specifically discussed below, although a similarly purposed module may be implemented in other ways in other examples. The training application 720 may implement training and assessment of an operator of the power machine 600, as described in greater detail herein.

For example, in some configurations, the training application 720 (when executed by the electronic processor 700) may facilitate a training session in which an operator of the power machine 600 may learn how to operate the power machine 600. Such a training session may be a guided training session related to basic operation of the power machine 600 (e.g., how to start an engine of the power machine 600; how to operate work lights of the power machine 600; how to tilt a work element of the power machine 600; how to move the power machine 600 in a forward direction or a backward direction; etc.). Alternatively, or in addition, in some instances, the training application 720 (when executed by the electronic processor 700) may facilitate a guided training session related to a particular operation or work task of the power machine 600 (e.g., how to perform a roading operation; how to perform a digging operation; how to dump a load into a dump truck; etc.), a feature of the power machine 600 (e.g., how to implement and use a ride control feature, a creep mode feature, a bucket shake feature, a float feature, a steering drift feature, a feather feature, etc.), etc. A training session may include a single operation or task (e.g., press a power-on button) or a series or sequence of operations or tasks (e.g., press a power-on button, move the joystick to the right, and press the foot pedal).

As described in greater detail herein, in some instances, a learning objective or focus of a training session may be selected by an operator of the power machine 600 (e.g., via the operator interface device(s) 635), an owner of the power machine 600 (e.g., where a rental operator of the power machine 600 is to complete the training session), etc.

Alternatively, or in addition, in some configurations, the learning objective or focus of the training session may be selected automatically, such as, e.g., based on a monitored use of the power machine 600 or a learned operator behavior, as described in greater detail herein. For instance, in some configurations, the technology disclosed herein may monitor a present operation or control of the power machine 600 by an operator (e.g., a monitored use of the power machine 600). Based on the monitored use of the power machine 600, the technology disclosed herein may determine a recommendation for improving operation of the power machine 600, such as, e.g., a recommended training session related to improving operation of the power machine 600. In some instances, a recommendation may be provided to an operator of the power machine 600 (e.g., via the operator interface device(s) 635, such as the display device 660) such that the operator may determine whether or not to implement the recommendation (e.g., approve or deny implementation of the recommendation). For example, the operator may be prompted to participate in a recommended training session (as the recommendation).

Alternatively, or in addition, in some configurations, the training application 720 may facilitate an assessment session in which an operator of the power machine 600 is prompted to perform various operations or tasks with respect to the power machine 600, during which, the operator’s performance is monitored to determine a proficiency level (e.g., an ability or capability of the operator to perform the various operations or tasks). As described in greater detail herein, in some configurations, the proficiency level may be utilized to determine an operating mode for the power machine 600. As one example, the power machine 600 may operate in a training mode (or a lock out mode) during an assessment session (e.g., a mode where functionality of the power machine 600 is restricted or limited). Based on an assessment of the operator’s proficiency level during the assessment session, the power machine 600 may operate in a different mode, such as, e.g., an un-locked mode or a normal operation mode (e.g., a mode where functionality of the power machine 600 is not restricted or less restricted than in the training mode). For instance, the assessment session may be utilized to establish (or otherwise determine) a capability of an operator prior to granting the operator access to unrestricted (or otherwise less restricted) power machine functionality.

As one specific example, in the context of a rental power machine, an owner of the rental power machine may want to assess a proficiency level of a rental operator prior to renting or allowing use of the rental power machine by the rental operator. In such situations, rental operators of rental power machines are generally novice operators that have minimal or no heavy equipment experience or familiarity with operating heavy equipment, let alone with respect to the particular power machine being rented. Accordingly, in some configurations, the technology disclosed herein may advantageously facilitate training (and assessment) of a rental operator before the rental power machine may be unlocked. In some examples, such training and assessment may occur on-site at a rental facility. For example, as described in greater detail herein, the technology disclosed herein facilitates walking a rental operator through a tutorial or test (e.g., a training session or an assessment session) such that competency of that rental operator may be understood (e.g., determine whether the rental operator understands the various operator input commands).

In some configurations, the training application 720 may implement training and assessment of an operator of the power machine 600 using a virtual environment. As used herein, a virtual environment may be a representation of an operating or working environment of the power machine 600. The virtual environment may include, e.g., a virtual reality (VA) environment, an augmented reality (AR) environment, a mixed reality (MR) environment, an extended reality (XR) environment, etc. For instance, the training application 720 may generate a virtual environment in which an operator of the power machine 600 is to participate in a training session or an assessment session.

In some instances, the training application 720 may generate the virtual environment to represent a hypothetical or example work environment of the power machine 600 (e.g., a default work environment). Alternatively, or in addition, the training application 720 may generate the virtual environment to represent an actual work environment of the power machine 600 (e.g., a work environment that the power machine 600 is presently located at). In such instances, the training application 720 may generate the virtual environment based on information or data that describes the actual surrounding or work environment of the power machine 600. As noted herein, in some instances, the sensor(s) 630 may include one or more image sensors (e.g., a large-field camera, such as a 360-degree camera). Alternatively, or in addition, the sensor(s) 630 may include additional or different sensors, such as, e.g., infrared (IR) sensors, light detection and ranging (LiDAR) sensors, thermal sensors, ultrasonic sensors, etc., to detect an actual work environment of the power machine 600. In some examples, the training application 720 may access (or otherwise retrieve) sensor data from the sensor(s) 630 and generate the virtual environment based on the sensor data. Alternatively, or in addition, the training application 720 may generate the virtual environment based on other information or data related to an actual work environment. As one specific example, the training application 720 may utilize information or data related to a work site plan, a present orientation or position of the power machine relative to the work site plan, etc. in order to generate the virtual environment.

In some configurations, the training application 720 may provide the virtual environment to an operator of the power machine 600 via a display device (e.g., the display device 660). In some instances, the training application 720 may provide the virtual environment using an integrated display. The integrated display may be integrated into a window, a door, or another portion of the power machine 600 that is formed of a display material allowing at least partial visibility through the display material to a work area outside of a cab of the power machine 600. Such an integrated display may be one specific example of the display device 660.

When a training or assessment session is implemented using a virtual environment, operation of the power machine 600 may be virtually represented within the virtual environment (as opposed to operation of the power machine 600 within an actual work environment). For example, while participating in a training or assessment session within a virtual environment, an operator may provide a command to perform an operation responsive to the prompt(s) of the training or assessment session. Responsive to the command, the virtual environment may virtually represent the power machine 600 performing the command (without causing the power machine 600 to perform the operation within the actual work environment). Accordingly, in some instances, the virtual environment may include a virtual representation of the power machine 600 (or component(s) thereof). As such, a virtual representation of the power machine 600 (or component(s) thereof) may be controlled within the virtual environment to virtually depict operator commands received within the virtual environment. Accordingly, in some configurations, the training application 720 may provide feedback (e.g., in real-time or near real-time) to an operator while the operator participates in a training or assessment session through the virtually representing an outcome or result of an operator command within the training or assessment session.

Alternatively, or in addition, in some instances, the training application 720 may provide feedback to an operator during a training or assessment session using another component, such as, e.g., one or more other operator interface devices 635. As one example, the feedback may be provided as an audio signal via the microphone 655. Such audible feedback may be provided using voice-integration functionality, as described herein. As another example, the feedback may be provided via an operator input device, such as, e.g., a joystick, a foot pedal, etc. In some instances, the training application 720 may control an operator input device to provide haptic feedback to an operator. As one specific example, feedback may be provided by physically moving a joystick in an orientation associated with an on-going training or assessment session. As another specific example, feedback may be provided by controlling a joystick to provide an opposing force or vibration in response to detecting that an operator is moving the joystick in the wrong direction.

Accordingly, in some instances, the technology disclosed herein may implement an operator input device configured to provide haptic feedback to an operator of a power machine as described by International Application No. PCT/US2025/024880, filed Apr. 15, 2025, which claims priority to U.S. Provisional Application No. 63/635,231, filed Apr. 17, 2024, the entire contents of which are incorporated herein by reference.

In some configurations, the training application 720 (when executed by the electronic processor 700) may access a training and assessment database 725 as part of facilitating the training or assessment functionality described herein (e.g., a training session, an assessment session, etc.). As illustrated in FIG. 7, the training and assessment database 725 may include training and assessment data 730 (also referred to herein as “training data” or “assessment data”). In some examples, the training and assessment data 730 may include training materials or information for the power machine 600. In some instances, the training and assessment data 730 may be specific to the power machine 600 (e.g., based on a model of the power machine 600, a machine type of the power machine 600, another type of characteristic or attribute of the power machine 600, etc.). In some examples, the training information (e.g., the training and assessment data 730) may include content describing one or more steps or actions for performing an operation or a work task with the power machine 600. As one example, the training information may be related to facilitating a training session for an operator of the power machine 600 (e.g., data for executing or otherwise providing a training session to an operator of the power machine 600). Alternatively, or in addition, in some examples, the training and assessment data 730 may include assessment materials or information related to assessing an operator’s capabilities (e.g., a proficiency level of an operator of the power machine 600). For example, the assessment information may include (or otherwise define) criteria that, when demonstrated or otherwise satisfied, indicates achievement of a particular proficiency level. As one specific example, the assessment information may include a grading or evaluation rubric for performance of a particular operation, work task, or action with the power machine 600. Alternatively, or in addition, the training and assessment data 730 may include information or data related to implementing a virtual environment, such as, e.g., a default virtual environment, data for generating a virtual environment representative of an actual work environment (e.g., the sensor data 790), etc.

As illustrated in FIG. 7, the memory 705 may include a voice-command application 740. The voice-command application 740 may be a software application executable by the electronic processor 700 in the example illustrated and as specifically discussed below, although a similarly purposed module may be implemented in other ways in other examples. The voice-command application 740 may facilitate the implementation of voice integration for the power machine 600 (e.g., facilitate voice-commands), as described in greater detail herein.

As described in greater detail herein, the voice-command application 740 (when executed by the electronic processor 700) may receive an audio input signal as a voice-command from an operator of the power machine 600 (e.g., also referred to herein as a user query or a query). The audio input signal may be captured using, e.g., the microphone 655 of FIG. 6. As described in greater detail herein, the voice-command application 740 (when executed by the electronic processor 700) may control the power machine 600 based on the audio input signal. For example, the audio input signal may be a user query requesting a particular action or operation to be performed by the power machine 600 (e.g., a command). Alternatively, or in addition, the audio input signal may be a user query requesting information related to the power machine 600, such as, e.g., static machine information (e.g., predetermined machine information or data, such as information from an owner’s manual for the power machine 600) or dynamic machine information (e.g., information or data collected via the sensor(s) 630). In some examples, the voice-command application 740 (when executed by the electronic processor 700) may provide, as a response to the user query (or the audio input signal), an output to the operator of the power machine 600, such as, e.g., a visual output displayed via the display device 660, an audio output signal via the speaker 650 (e.g., an audible speech representation of a response to the user query), etc.

In some configurations, the voice-command application 740 (when executed by the electronic processor 700) may facilitate voice-command integration for controlling the power machine 600 by invoking (or otherwise executing) one or more artificial intelligence (AI) or machine learning models, as described in greater detail herein. As such, in some configurations, the memory 705 may include a learning engine 745 and a model database 750, that stores one or more models 755.

In some configurations, the learning engine 745 develops a model using an AI or machine learning function. Machine learning functions are generally functions that allow a computer application to learn without being explicitly programmed. In particular, the learning engine 745 is configured to develop a model based on training data. As one example, to perform supervised learning, the training data includes example inputs and corresponding desired (for example, actual) outputs, and the learning engine 745 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 745 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 745 to ingest, parse, and understand data and progressively refine models. In some configurations, the learning engine 745 may develop one or more large language models (LLMs) 760, another model described herein, or the like. For example, in some configurations, the learning engine 745 may develop one or multiple models that may be utilized across different tasks performed by the technology disclosed herein described herein.

Accordingly, as illustrated in FIG. 7, in some configurations, the model database 750 may store the LLM(s) 760. Generally, the LLM(s) 760 may include a deep AI or machine learning model that can comprehend and generate human language text. For instance, the LLM(s) 760 may be configured to determine meanings (or context) from a sequence of words and understand relationships between those words and, ultimately, perform a task based on that understanding. For instance, the LLM(s) 760 may perform a variety of natural language processing (NLP) related tasks to produce content based on input prompts in human language. Such tasks may generally include answering questions (e.g., generating a response to a user query), text generation, content summary, etc. The LLM(s) 760 may be an artificial neural network that is trained using self-supervised learning, semi-supervised learning, or a combination thereof.

As illustrated in FIG. 7, the memory 705 may include a command database 765 that stores one or more commands 770. The command(s) 770 may include a list of commands that may be performed by the power machine 600 (e.g., one or more operations, operational parameters, tasks, feature, etc. to be performed by the power machine 600). In some configurations, the command(s) 770 may be include a list of predetermined commands that may be implemented via a voice-command. In some configurations, the command(s) 770 may include (or otherwise relate to), e.g., a start engine command, a stop engine command, a turn on work lights command, a turn off work lights command, a set drive mode response command (to low, medium, or high), a set workgroup response command (e.g., to low, medium, or high), a set creep mode speed command (e.g., to number 1-99), a set iso pattern command, a set H pattern command, an enable creep mode command, a disable creep mode command, a set low range command, a set high range command, a shake bucket command, a float command, a single swipe wipe command, an adjust steering drift command, an adjust max forward speed command, an adjust max reverse speed command, etc.

As illustrated in FIG. 7, the memory 705 may include a machine information database 780. The machine information database 780 may store machine information 785 and sensor data 790. The machine information 785 may include predetermined information related to the power machine 600 (e.g., static machine information). For example, the machine information 785 may include an owner’s manual for the power machine 600, a How-To Guide for the power machine 600, etc. As one specific example, the machine information 785 may include a maintenance schedule for the power machine 600. As another specific example, the machine information 785 may include one or more specifications or ratings related to the power machine 600, such as, e.g., an operational specification or rating related to an actuator or other component of the power machine 600. As yet another specific example, the machine information 785 may include identifying information for the power machine 600, such as, e.g., a model number of the power machine 600, a retailer associated with the power machine 600, a year of manufacture of the power machine 600, etc. The sensor data 790 may include the information or data collected via the sensor(s) 630. As such, in some instances, the sensor data 790 may be dynamic or changing (e.g., dynamic machine information). As such, in some instances, references to the machine information 795 may include the sensor data 790 (e.g., as dynamic machine information). For example, the sensor data 790 may indicate a travel speed of the power machine 600, a location or position of an implement or work element, a geographical location of the power machine 600, an extension amount of an actuator of the power machine 600, etc. In some configurations, the machine information database 780 may include previous or historical machine information or sensor data (e.g., previous sensor data, a previous version of an owner’s manual, etc.). Alternatively, or in addition, in some configurations, the machine information database 780 may include temporally current or present machine information or sensor data (e.g., live sensor data, a current version of an owner’s manual, etc.).

The memory 705 may include additional, different, or fewer components in different configurations than illustrated in FIG. 7. Alternatively, or in addition, in some configurations, components of the memory 705 may be combined into a single component, distributed among multiple components, or the like. Alternatively, or in addition, in some configurations, a component of the memory 205 may be stored remotely from the controller 590.

As noted herein, in some instances, the technology disclosed herein may allow voice-command integration for the power machine 600. Such voice-command integration may allow an operator of the power machine 600 to implement various types of power machine functionality verbally, such as, e.g., setting an operational parameter of the power machine (e.g., to set a speed), enabling/disabling a feature of the power machine (e.g., to activate a ride-control feature, to set an operational parameter for the feature, etc.), accessing power machine information (e.g., a maintenance schedule, training information, etc.), execution or participation in a training session, etc.

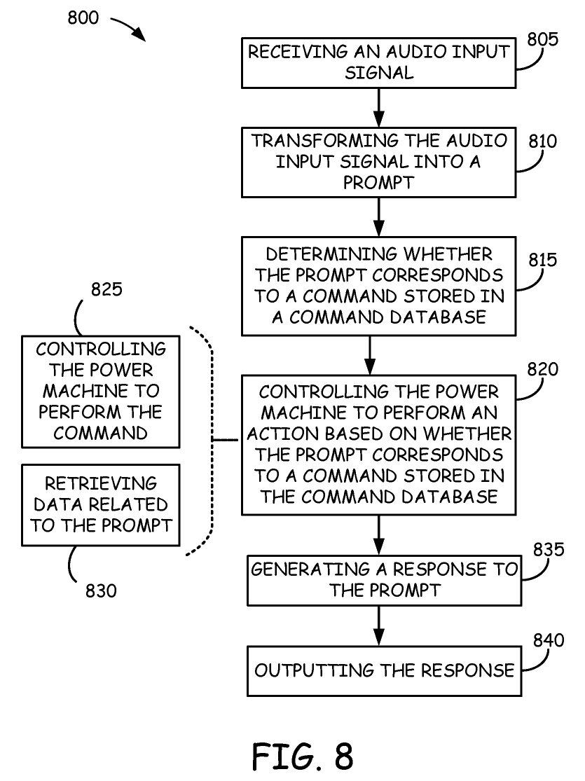

FIG. 8 is a flowchart illustrating a method 800 for implementing voice-commands for controlling a power machine (e.g., the power machine 600) according to some configurations. In some configurations, the method 800 can be performed by the control system 610 (e.g., the controller 690) and, in particular, by the electronic processor 700 of the controller 690 (e.g., by executing the voice-command application 740 and one or more of the model(s) 755). However, as noted above, the functionality described with respect to the method 800 may be performed by other devices or can be distributed among a plurality of devices or components (e.g., one or more electronic processors).

As illustrated in FIG. 8, the method 800 may include receiving, with the electronic processor 700, an audio input signal (at block 805). The audio input signal may be a voice-command provided by an operator of the power machine 600, such as, e.g., a command to be performed by the power machine 600, a request for power machine information, etc. As used herein, a voice-command may also be referred to as a user query.

For example, the microphone 655 may capture (or otherwise record) the voice-command provided by the operator of the power machine 600. In some instance, the operator of the power machine 600 may activate an audio input mechanism (e.g., one of the operator interface devices 635) to provide (e.g., a voice-command) the audio input signal (e.g., a voice-command). In such instances, the microphone 655 may actively capture (or otherwise record) the audio input signal responsive to an audio input mechanism being activated. In some examples, the microphone 655 may actively capture the voice-command for a predetermined time period responsive to the audio input mechanism being activated. For example, after a press and release interaction with a push button (as the audio input mechanism), the microphone 655 may capture the audio input signal for 30 seconds after the push button is released. Alternatively, or in addition, in some examples, the microphone 655 may actively capture the audio input signal while the audio input mechanism is activated (e.g., remains activated). For example, the microphone 655 may capture the audio input signal while a push button (e.g., the audio input mechanism) is depressed (e.g., activated), but may stop capturing the audio input signal when the push button is no longer depressed (e.g., not activated). Alternatively, or in addition, the microphone 655 may continuously capture audio input signals from the operator of the power machine 600. In such instances, the audio input signal may be processed in order to detect specific commands or triggers indicative of an operator providing a voice-command (as opposed to audio signals not related to a voice-command for controlling the power machine 600).

The electronic processor 700 may transform the audio input signal into a prompt (at block 810). The prompt may represent the audio input signal (e.g., a text-based representation of the audio input signal). In some configurations, the electronic processor 700 may transform the audio input signal into the prompt by executing (or otherwise invoking) one or more of the models 755. For example, in some instances, the electronic processor 700 may provide the audio input signal to an automatic speech recognition (ASR) model (as one of the models 755). Generally, an ASR model may convert (or otherwise transcribe) an audio signal (e.g., spoken language) into text (e.g., written text), which may be referred to as a prompt. Accordingly, in some instances, when the electronic processor 700 receives a voice-command (e.g., the audio input signal) from the operator of the power machine 600, the electronic processor 700 may provide the audio input signal to an ASR model in order to transcribe the audio input signal into text (e.g., the prompt).

The electronic processor 700 may determine whether the prompt corresponds to one of the commands 770 stored in the command database 765 (at block 815).

In some configurations, the electronic processor 700 may determine whether the prompt corresponds to (or otherwise matches) a command stored in the command database 765 by executing (or otherwise invoking) one or more of the models 755 stored in the model database 750. For instance, the electronic processor 700 may provide the prompt to a matching model that is specifically developed (or trained) to match prompts to commands stored in the command database 765. The electronic processor 700 may receive a response from the matching model, where that response may indicate whether the prompt matches a command in the command database 765. When a match is identified, the response may identify the command that matches the prompt and, in some instances, the response may include information related to the command (e.g., instructions or other data related to performing the command).

In some configurations, prior to determining whether the prompt corresponds to one of the commands 770 stored in the command database 765 (e.g., at block 815), the electronic processor 700 may classify the prompt (e.g., determine a classification of the prompt). For example, the classification may indicate whether the prompt is a request for machine information, a command to be performed by the power machine, etc. In some configurations, the electronic processor 700 may use the classification of the prompt when determining whether the prompt corresponds to one of the commands 770 stored in the command database 765. For instance, in some configurations, the electronic processor 700 may provide the prompt and the classification of the prompt to the model(s) 755 (e.g., a matching model) such that the model(ss) 755 may determine whether there is a match based on the prompt, the classification of the prompt, or a combination thereof.

The electronic processor 700 may control the power machine 600 to perform an action based on whether the prompt corresponds to one of the commands 770 stored in the command database 765 (at block 820).

When the prompt corresponds to a command stored in the command database 765, the electronic processor 700 may control the power machine 600 to perform the command (at block 825). For example, when the command relates to enabling/disabling a creep mode of the power machine 600, the electronic processor 700 may enable/disable the creep mode of the power machine 600. As another example, when the command relates to setting a speed of the power machine 600 to an operator-requested speed (as indicated in the voice-command provided by the operator), the electronic processor 700 may set a speed of the power machine 600 (e.g., an operational parameter related to speed of the power machine 600) to the operator-requested speed.

One specific example may involve a variable or maximum flow with respect to a grabble bucket and auger. In such examples, an operator using a grapple bucket may “feather” the flow to slowly move cylinders or perform maximum flow for an auger to shake dirt. Following this example, the technology disclosed herein may facilitate implementation of such functionality via voice-command.

Another specific example may involve a speed management feature with respect to a snowblower attachment. In such examples, an operator using a snowblower attachment should only drive the power machine 600 as fast as the snowblower attachment can clear snow. In this example, the operator may use voice-command to set speed management to an exact number without going up and down from 1-99. In some cases, the AI or machine learning technology described herein may “learn” operator behavior based on job site, how much snow, etc., and utilize such information to set the speed management.

Yet another specific example may involve a drift management feature with respect to a planer or trencher attachment. A drift management feature (or steering drift compensation) may attempt to maintain the power machine 600 on a straight path when using attachments, such as, a planer attachment or a trencher attachment, that may pull the power machine 600 to the side. In this example, an operator can use voice-commands to keep hands on a joystick (e.g., holding the joystick straight) to find what adjustments need to be made to keep driving straight.

Yet another specific example may involve a workgroup response feature with respect to a pallet fork attachment. In this example, an operator may use voice-commands to active a workgroup response feature in order to slow down pallet fork loading for precise controls.

When the prompt does not correspond with a command stored in the command database 765, the electronic processor 700 may retrieve data related to the prompt (at block 830). For example, in some cases, the prompt may be a request for machine information, such as, e.g., information included in an owner’s manual of the power machine 600, machine vitals (or sensed data) of the power machine 600, etc. Accordingly, in such cases, the electronic processor 700 may access (or otherwise retrieve) the machine information as requested by the operator via the voice-command.

In some configurations, the electronic processor 700 may retrieve data related to the prompt using one or more of the models 755 stored in the model database 750. For instance, the electronic processor 700 may provide the prompt to the model(s) 755. As one example, the electronic processor 700 may provide the prompt to a retrieval-augmented generation (RAG) model (e.g., as one of the models 755 stored in the model database 750). Responsive to receipt of the prompt, the RAG model may retrieve, based on the prompt, relevant information or data, such as, e.g., from the machine database 780 (or the machine information 785 or the sensor data 790). In some instances, the RAG model may then augment the prompt to include the retrieved information (e.g., the machine information 785 or the sensor data 790). After augmenting the prompt with the retrieved information, the RAG model may generate a response to the audio input signal (e.g., the voice-command) based on the prompt as augmented with the retrieved information. The RAG model may ultimately provide the response to the electronic processor 700 (or another component of the controller 590).

As one specific example, when the voice-command is a request related to maintenance of the power machine 600, the RAG model may retrieve, from the machine database 780, a portion of the machine information 785 or the sensor data 790 related to maintenance of the power machine 600. After retrieving the portion related to maintenance, the RAG model may then generate a response to the request related to the maintenance. For instance, when the request specifically inquiries about a frequency at which a fluid system of the power machine 600 should be flushed, the RAG model may generate a response to the request based on the portion of the machine information 785 or the sensor data 790 related to maintenance, and, in some instances, a portion specifically related to fluid system maintenance for the power machine 600.

Alternatively, or in addition, in some configurations, the electronic processor 700 may retrieve the data related to the prompt such that the electronic processor 700 may control the power machine 600 to perform a command (e.g., as requested via the voice-command). For example, in some instances, in order to perform the command, the electronic processor 700 may access additional data or information (e.g., the machine information 780, the sensor data 790, etc.), where that additional data or information is utilized in the performance of the command. As such, in some configurations, the electronic processor 700 may retrieve the data related to the prompt in situations other than just when the prompt does not correspond to a command stored in the command database 765.

The electronic processor 700 may generate a response to the prompt (at block 835). In some examples, the response may include information related to the action (e.g., as performed at block 820). For example, the response may indicate a status or success of the action (e.g., a confirmation that the action was performed by the power machine 600, either successfully or unsuccessfully). As another example, the response may indicate what action was performed by the power machine 600 (e.g., enablement of a ride-control feature). Alternatively, or in addition, in some configurations, the response may include machine information as requested by an operator of the power machine 600 via the voice-command (or user query). For example, the response may include a maintenance schedule for the power machine 600.

In some examples, the electronic processor 700 may generate the response to the prompt using one or more of the LLMs 760. For example, the electronic processor 700 may provide information related to performance of the action to the LLM(s) 760. Responsive to receive of such information, the LLM(s) 760 may generate a text-based response (e.g., a written text or statement) related to the information. For instance, the LLM(s) 760 may generate a human-readable response, which may provide an answer to a user query (whether as confirmation of the performance of a command or as machine information specifically requested by the operator).

As one specific example, when the action performed by the power machine 600 involves a successful enablement of a ride-control feature, the electronic processor 700 may provide data indicating that a ride-control feature was successful enabled for the power machine 600, and the LLM(s) 760 may generate a response as follows: “The ride-control feature was successfully enabled.” As another specific example, when the action performed by the power machine 600 involves retrieving machine information, the electronic processor 700 may provide data indicating that a maximum travel speed for the power machine 600 is 10 mph to the LLM(s) 760, the LLM(s) 760 may generate a response as follows: “The maximum travel speed recommended for this machine is 10 mph.”

The electronic processor 700 may output the response to an operator of the power machine 600 (at block 840). In some examples, the electronic processor 700 may output the response as a visual output, such as, e.g., via a user interface displayed on the display device 660. The visual output may include various content or media types or formats. For instance, the visual output may include text, a video, an animation, an image, an electronic file, a live data steam, a graph or chart, etc. As one specific example, when the user query is: “What light bar does this machine have?”, the visual output may include a text-based output responding to the use query (e.g., “LED Light Bar for Utility Vehicles – Part No. 46933504.”). As another specific example, when the user query is: “How do I check track tension on my machine?”, the visual output may include a how-to video or a graphical representation of how to check track tension on the power machine 600. As still another specific example, when the user query is: “Provide live fluid pressure data.”, the visual output may be text that includes a numerical indication of the fluid pressure, where the numerical indication is continuously updated to reflect a present fluid pressure. As such, in some cases, a query may relate to controlling the display of data or information to an operator of the power machine 600 (e.g., what data is displayed, how data is displayed, etc.).

Accordingly, in some instances, outputting the response as a visual output may be advantageous to the operator of the power machine 600, such as, e.g., when content of the response is more easily interpretable as a visual output (e.g., a part number, a graphical diagram, a table, a how-to video or demonstration, etc.), when an ambient noise level may interfere with the operator hearing an audible output, etc. As such, in some cases, the electronic processor 700 may determine how to output the response (e.g., as a visual output, an audible output, or a combination thereof). In some instances, how a response is output may be based on the retrieved data (e.g., the machine information 785, the sensor data 790, etc.), a present operation or status of the power machine 600 (e.g., while the power machine 600 is actively roading, while the power machine 600 is sitting idle, etc.), the user query or the audible input signal, a characteristic of the response (e.g., a character or word length of the response, a readability of the response, a format or feature of the received data to be included in the response, etc.) Alternatively, or in addition, in some instances, the electronic processor 700 may output the response as an audible output signal as well as a visual output (e.g., as redundant outputs). By outputting the response as both an audible output signal and a visual output, an operator of the power machine 600 may be allowed to confirm the user query, the response or action taken responsive to the user query, etc. In some cases, the audible output signal and the visual output may provide the same or substantially similar content or data to an operator of the power machine. For example, the audible output signal and the visual output may each provide a temperature reading to the operator of the power machine 600. Alternatively, or in addition, in some cases, the audible output signal and the visual output may be different. For example, the visual output signal may provide a part number while the audible output signal may notify (or otherwise indicate) that the part number is being provided to the operator via the display device 660 (as the visual output).

Alternatively, or in addition, in some examples, the electronic processor 700 may output the response as an audio output signal, such as, e.g., a verbal or speech output. In such configurations, the electronic processor 700 may provide the response to one or more of the models 755 of the model database 750. As one example, the electronic processor 700 may provide the response to a text-to-speech model (e.g., the model(s) 755) that is specifically developed (or trained) to generate human-like speech from text. Accordingly, responsive to receipt of the response, the text-to-speech model may generate an audio output signal that represents the response. The text-to-speech model may provide the audio output signal to the electronic processor 700. The electronic processor 700 may then output the audio output signal, such as, e.g., via the speaker 650, such that an operator of the power machine 600 may be verbally provided the response to the operator’s voice-command.

In some specific examples, the technology disclosed herein may provide diagnosis and troubleshooting for the power machine 600. For example, the power machine 600 may provide various machine status codes to an operator. As used herein, a machine status code may indicate a status of the power machine 600. A machine status code may include, e.g., an error code or a service code of the power machine 600. An error code indicates an issue, fault, or malfunction related to the power machine 600 (e.g., a hydraulic pressure issue, an engine fault, a software fault, etc.). A service code indicates maintenance or service related events of the power machine 600 (e.g., change oil, inspect filter, schedule maintenance check, etc.). In some instances, an operator may not readily recognize or understand what the machine status code is referring to due to, e.g., the vast number of machine status codes for a given power machine and the seemingly random combinations of characters, making machine status codes generally unintuitive humans. Further, an operator may not readily recognize or understand a severity or urgency of the machine status code, a remedial action for the machine status code, etc. As one specific example, during operation of the power machine 600, an operator may struggle to assess how to respond to a machine status code on the fly (e.g., whether the machine status code warrants stopping operation of the power machine 600 to immediately respond to the machine status code or whether the machine status code may be addressed at a later point in time). Accordingly, in some instances, the technology disclosed herein may advantageously allow for real-time (or near real-time) diagnostic and troubleshooting for the power machine 600.

While implementation of the technology with respect to diagnosis and troubleshooting of the power machine 600 is described herein with respect to an active machine status code provided by the power machine 600, it should be understood that the technology disclosed herein may be implemented with respect to diagnosis and troubleshooting of the power machine 600 without an active machine status code being provided by the power machine 600. For example, in some instances, an operator may provide a user query relating to diagnosis and troubleshooting of the power machine 600, including a specific machine status code of the power machine 600, regardless of whether the power machine 600 has actually provided a machine status code.

In such instances, a user query (e.g., a voice-command) may relate to diagnostics or troubleshooting the power machine 600, and, in particular, a machine status code of the power machine 600. In some configurations, a user may generate a user query based on an machine status code of the power machine 600. As one specific example, responsive to receiving a machine status code, the user may provide (e.g., as an audio input signal) a user query such as: “What does that code mean?”. Alternatively, or in addition, in some instances, when a machine status code is provided, the technology disclosed herein may automatically provide (or generate) a user query related to the machine status code (without human intervention or involvement).

Accordingly, with reference to FIG. 8, in some instances, the electronic processor 700 may receive an audio input signal (or another type of input) related to a machine status code of the power machine 600 (e.g., as described herein at block 805). The electronic processor 700 may transform the audio input signal (or another type of input) related to the machine status code into a prompt (e.g., as described herein with respect to block 810 of FIG. 8). The electronic processor 700 may control the power machine 600 to perform an action based on whether the prompt corresponds to a command stored in the command database 765 (as described herein with respect to block 815 of FIG. 8). However, in some instances, the electronic processor 700 may omit determining whether the prompt corresponds to a command stored in the command database 765.

In some configurations, the electronic processor 700 may access (or otherwise retrieve) data or information related to the machine status code. In some instances, the electronic processor 700 may access data related to the prompt as similarly described herein with respect to the method 800 of FIG. 8 (e.g., block 830). As one example, the electronic processor 700 may retrieve information from one or more controllers, a CAN network, a communication network, or the like of the power machine 600. As another example, the electronic processor 700 may retrieve at least a portion of the sensor data 790 from the machine database 780, where the retrieved portion of the sensor data 790 is related to (or otherwise relevant to) the machine status code. As yet another example, the electronic processor 700 may retrieve information related to the machine status code itself. For instance, the electronic processor 700 may access the machine information 785 (e.g., a portion of the machine information 785 corresponding to machine status codes or the specific machine status code that was provided by the power machine 600). In such instances, the machine information 785 may be manufacturer generated resources, information, or data (e.g., user manuals, maintenance schedules, etc.). In some examples, the electronic processor 700 may utilize a RAG model to retrieve the data or information related to the machine status code, as described herein.

In some configurations, the electronic processor 700 may generate a response to the user query (e.g., a corresponding prompt). In some instances, the electronic processor 700 may generate the response as similarly described herein with respect to the method 800 of FIG. 8 (e.g., block 835). In some examples, the response may include the data or information retrieved based on the user query (or corresponding prompt). Accordingly, in some instances, the response may include information specific to or otherwise relating to a machine status code of the power machine 600. For example, the response may provide an explanation or description of the machine status code, indicate a relevant component or system of the power machine 600 to which the machine status code relates to (e.g., a component or system that the machine status code was generated for), a severity of the machine status code (e.g., an informational machine status code, a severe machine status code that involves immediate attention, a moderate machine status code that involves attention at some point in the future, etc.), etc.

In some instances, a response may provide one or more recommendations (or remedial actions) for how an operator of the power machine 600 may troubleshoot the machine status code (e.g., on site). The response may provide information related to how to locate a component (e.g., where the component is located on the power machine 600, how to access the component, tools involved in accessing the component, etc.). In some examples, the response may include or identify a recommended troubleshooting resource (e.g., training information, a training session, etc.) to the operator, such as, e.g., a video or a guide that includes instructions on how to check electrical connections or how to determine if electrical cables are damaged. The response may include information related to tools involved in troubleshooting the machine status code. Alternatively, in some instances, the technology disclosed herein may determine that an operator is not qualified to remediate the machine status code and provide a response that indicates the machine status code involves action by a service or maintenance entity.

In some instances, the response may indicate one or more suggested replacement components (e.g., by part number, name, etc.). Such suggested replacement components may be specifically tailored to the specific power machine 600 (e.g., based on a year, a model, a machine type, etc. of the power machine 600). In some instances, the response may indicate a likelihood of which component may need replacing (e.g., based on maintenance history of the power machine 600 (or component(s) thereof), an operational history or tendencies of the power machine 600, etc.).

A response may indicate a potential cause of the machine status code. For example, the technology disclosed herein may analyze the machine information 785, the sensor data 790, etc. in order to determine patterns or trends with respect to operation of the power machine 600 (e.g., operator behavior, machine behavior, etc.). In some instances, based on such patterns or trends, the technology disclosed herein may identify a root cause of the machine status code. As one specific example, when the machine information 785 or the sensor data 790 indicates a tendency to overwork one or more components of the power machine 600 and the machine status code relates to one of the overworked components, the response may suggest modifying operation of one of the overworked components in order to remediate the machine status code. In some configurations, the response may indicate a potential future machine status code that may occur if the cause of the machine status code is not addressed. Following the previous example, the response may indicate that a different, more severe machine status code is likely to occur if operation of the overworked components is not modified. Such pattern or trend recognition or classification may be implemented using one or more AI models (e.g., the model(s) 755), as described herein.

In some instances, a response may involve a dialogue with an operator (e.g., a back-and-forth exchange of communication). For instance, when a response involves multiple remedial actions (or troubleshooting steps) (e.g., training information or a training session), the technology disclosed herein may provide a first troubleshooting step (as a first response) and, after the operator indicates completion of the first troubleshooting step, provide a second troubleshooting step (as a second response).

As one specific example, when the machine status code relates to a registration plate lamp fault, the response may include: “This machine status code indicates that a lamp for the registration plate may not be working. Confirm whether the lamp for the registration plate is working. If the lamp is not working, you could consider checking whether the electrical connections are secure, whether any electrical cables are damaged, or whether the lamp shows damage. Otherwise, please consider making a service call. Potential replacement parts may include: the lamp (Part No. 12345); or the electrical cable (Part No. 09887).”

As another specific example, when the machine status code relates to completing a calibration process for a tilt inclinometer of the power machine 600 being performed, the response may indicate include: “This machine status code indicates that the tilt inclinometer was calibrated. No action is necessary.”

In some configurations, the audio output signal may be translated from a first language to another language prior to being output to an operator of the power machine 600. In some instances, the audio output signal may be translated into a language understood by an operator of the power machine 600, an owner of the power machine 600, a renter of the power machine 600, a work site supervisor, etc. For example, in some cases, users or entities of the power machine 600 may communicate via different languages. As such, in some instances, the technology disclosed herein may facilitate communication between those users or entities by implementing one or more translation functions or functionality. As one specific example, an operator of the power machine 600 may communicate using a first language and a work site supervisor may communicate using a second, different language. Following this example, a work site supervisor may provide, as a user query in the second language, a description for a first work task to be performed at a work site with a request to translate the description to the first language. Responsive to receive of the user query in the second language, the technology disclosed herein may translate the description from the second language to the first language and output the description in the first language (as the response) to the operator of the power machine 600.

Alternatively, or in addition, in some instances, information or data utilized to generate a response to a user query may be in a language different than the language of the user query or the response. As one specific example, when an operator provides a user query relates to a question about a maintenance schedule for the power machine 600, the technology disclosed herein may utilize a maintenance schedule or a manual for the power machine 600 (e.g., the machine information 785) in order to generate the response to the user query. However, in instances where the maintenance schedule or the manual is in a language other than a language communicated by the operator, the technology disclosed herein may translate (a) the user query from a language of the operator to a language of the maintenance schedule or the manual or (b) the response from the language of the maintenance schedule or the manual to a language of the operator prior to outputting the response to the operator of the power machine 600.

Accordingly, in some configurations, the electronic processor 700 may provide the response to a translation model (e.g., one or more of the models 755 of the model database 750). As one example, the electronic processor 700 may provide the response to a translation model that is specifically developed (or trained) to translate between various languages. Accordingly, responsive to receipt of the response, the translation model may generate an audio output signal or a visual output that represents the response (as translated). The translation model may provide the audio output signal or the visual output to the electronic processor 700. The electronic processor 700 may then output the audio output signal or the visual output, such as, e.g., via the speaker 650 or the display device 660, respectively, such that an operator of the power machine 600 may be visually or verbally provided the response in a language understood by the operator.

In some specific examples, the technology disclosed herein may provide implement (or attachment) recognition and optimization for the power machine 600. For example, as described herein, various implements may be coupled to the power machine 600 for various operations or work tasks. However, in some instances, an operator of the power machine 600 may not be familiar with the specific implement, how to optimize performance of a work task based on the specific implement, how to control or operate the implement, constraints of the specific implement, etc. Accordingly, in some instances, the technology disclosed herein may advantageously allow for intelligent recognition, control, and performance optimization with respect to an implement of the power machine 600. As such, in some configurations, the technology disclosed herein may provide (or otherwise output as a response) to an operator of the power machine 600 an identification of the implement, recommended or suggested operational parameters, a recommended alternative implement, etc.

In some configurations, an operator may provide a user query related to an implement. Alternatively, or in addition, the technology disclosed herein may detect an implement or a change in implement (e.g., using image data captured by a camera or another image sensor of the power machine 600).

For example, in some configurations, the user query may relate to an implement of the power machine 600 (e.g., an implement presently coupled to the power machine 600, an implement to be coupled to the power machine 600, an implement that is compatible with the power machine 600, another type of implement, etc.). In some examples, the user query may include a description of the implement of the power machine 600 (e.g., an operator provided description of the implement). Such a description may describe a physical appearance of the implement, an operation or a work task to be performed with the implement, etc.

In some instances, with reference to FIG. 8, the electronic processor 700 may receive an audio input signal (or another type of input) related to an implement of the power machine 600 (e.g., as described herein at block 805). The electronic processor 700 may transform the audio input signal (or another type of input) related to the implement into a prompt (e.g., as described herein with respect to block 810 of FIG. 8). The electronic processor 700 may control the power machine 600 to perform an action based on whether the prompt corresponds to a command stored in the command database 765 (as described herein with respect to block 815 of FIG. 8). However, in some instances, the electronic processor 700 may omit determining whether the prompt corresponds to a command stored in the command database 765.

In some configurations, the electronic processor 700 may access (or otherwise retrieve) data or information related to the implement. In some instances, the electronic processor 700 may access data related to the implement as similarly described herein with respect to the method 800 of FIG. 8 (e.g., block 830). In some examples, the retrieved data may include an owner’s manual for the implement, manufacturer-generated content or resources, etc.

In some configurations, the electronic processor 700 may access data in order to identify (or otherwise recognize) the implement (or one or more characteristics thereof). In such configurations, the electronic processor 700 may access visual data of the implement, such as, e.g., one or more images or videos of the implement. The visual data of the implement may be collected using the sensor(s) 630, such as, e.g., an image sensor or the like. In some instances, the technology disclosed herein may determine an identification of the implement based on the visual data. For instance, in some cases, the technology disclosed herein may determine the identification of the implement based on one or more characteristics of the implement. The characteristic(s) of the implement may include, e.g., a classification or type of implement, a model number of the implement, a shape of the implement, a color of the implement, another type of identifying characteristic, etc. The technology disclosed herein may determine the identification of the implement using one or more AI models (e.g., the model(s) 755). For example, in some configurations, the electronic processor 700 may provide the visual data to the model(s) 755. The model(s) 755 may then determine an identification of the implement based on the visual data. In some instances, the electronic processor 700 may provide additional data to the model(s) 755 to be utilized in determining the identification of the implement. As one example, the electronic processor 700 may provide the visual data, the user query, the sensor data 790, the machine information 785, etc. In some configurations, the model(s) 755 may determine the identification of the implement using pre-existing information for various implements, such as, e.g., a list of implements that associates each implement with one or more characteristics. Such pre-existing information may include, e.g., manuals, documentation, or other resources (e.g., a collection of documentation related to various implements).

In some examples, after the implement is identified, the electronic processor 700 may output a response (e.g., as similarly described herein with respect to blocks 835, 840 of FIG. 8). For instance, the electronic processor 700 may output a response that indicates the identification of the implement. Alternatively, or in addition, in some configurations, the electronic processor 700 may output a response that indicates one or more recommended or suggested operational parameters for the power machine 600 or the implement (e.g., based on retrieved data related to the identification of the implement or a work task to be performed thereby).

In some examples, responsive to an operator of the power machine 600 approving or otherwise selecting the recommended or suggested operational parameters, the electronic processor 700 may implement those operational parameters with respect to the power machine 600 (or the implement thereof) such that during operation of the power machine 600 is controlled based on those operational parameters. Alternatively, or in addition, in some instances, the electronic processor 700 may automatically implement the recommended or suggested operational parameters without human intervention or involvement. For example, when a recommended operational parameter represents a constraint or limitation of the power machine 600, the electronic processor 700 may implement that recommended operational parameter with or without express approval or acknowledgement from an operator of the power machine 600. Further, in some instances, when an operator input attempts to modify a recommended operational parameter that represents a constraint or limitation of the power machine 600, the electronic processor 700 may override such an attempt by modifying the operator input or preventing execution of the operator input by the power machine 600.

Alternatively, or in addition, in some examples, after the implement is identified, the electronic processor 700 may prompt an operator of the power machine 600 for additional information. For instance, the electronic processor 700 may generate and output a request for additional information based on the identification of the implement (e.g., as similarly described herein with respect to blocks 835, 840 of FIG. 8). The additional information may relate to, e.g., an intended operation or work task to be performed by the implement, an environmental condition related to operation of the power machine with the implement, a characteristic of a material, etc.

As one specific example, when the implement is identified as a snowblower attachment, the operator of the power machine 600 may be prompted to provide a description of the snow or operating environment. For instance, the operator may be asked questions related to a snow type or density (e.g., light or fluffy snow, wet or heavy snow, icy or compacted snow, etc.), a snow depth (e.g., 3 inches or 2 feet), an ambient temperature, etc. Following this example, a snow type or density, a snow depth, and an ambient temperature may impact operation of the power machine 600, and, in particular, the implement. For instance, heavy, wet snow may involve a first set of operating parameters for the power machine 600 (or the implement thereof) while light, fluffy snow may involve a second set of operating parameters. As another specific example, when the implement is identified as an auger attachment, the operator of the power machine 600 may be prompted to provide a description of the material or operating environment. For instance, the operator may be asked questions related to material type (e.g., clay, soil, gravel, etc.), a moisture level (e.g., wet, dry, etc.), a compaction level (e.g., compact, loose, etc.), etc., as such information may impact operating parameters of the power machine 600 (or the implement thereof).

Alternatively, or in addition, the electronic processor 700 may determine the additional information without human intervention or involvement. As one example, the electronic processor 700 may determine environmental conditions using the sensor(s) 630. As one specific example, the electronic processor 700 may receive temperature related data from a temperature sensor (e.g., as an example of the sensor(s) 630).

In some configurations, the electronic processor 700 may provide the additional information (or a corresponding prompt) to the model(s) 755. The model(s) 755 may then determine one or more operational parameters or features for the power machine 600 (or the implement). Such operational parameters or features may be included (or otherwise indicated) by the response output to the operator. Example operational parameters may include: an auxiliary flow adjustment; an engine revolutions per minute (RPM); a lift speed; a tilt speed; a drive response; a speed management setting; a lift response; a tilt response; etc. Example features may include: a lift arm float feature, a ride control feature, a creep feature, etc.

As one specific example, when the implement is identified as a snow blade, a recommended operational setting for engine RPM may be a maximum RPM setting. As another specific example, when the implement is identified as a mower attachment, a recommended feature enablement for ride control may be “disabled” or “off.” As yet another specific example, when the implement is identified as a brush attachment and the material to be interacted with is grass or brush, a recommended operational setting for engine RPM may be a maximum RPM setting and a recommended feature enablement for ride control may be “disabled” or “off.” As still another specific example, when the implement is a sweeper and the material to be interacted with is light, fluffy snow, a recommended operational setting for engine RPM may be a medium RPM setting. As a contrasting example, when the implement is a sweeper and the material to be interacted with are wet leaves, a recommended operational setting for engine RPM may be a maximum RPM setting.

Alternatively, or in addition, in some configurations, the model(s) 755 may determine that a different implement is recommended based on, e.g., an anticipated work task or operation, an environmental condition, a characteristic of a material, etc. In some instances, the technology described herein may determine that a different implement is recommended based on the identification of the implement, the additional information, the retrieved data, etc. As one specific example, when the implement is a dozer blade attachment and the anticipated work task is leveling soil with surface debris, the model(s) 755 may recommend a landscape rake attachment, which functions to level soil while also collecting surface debris.

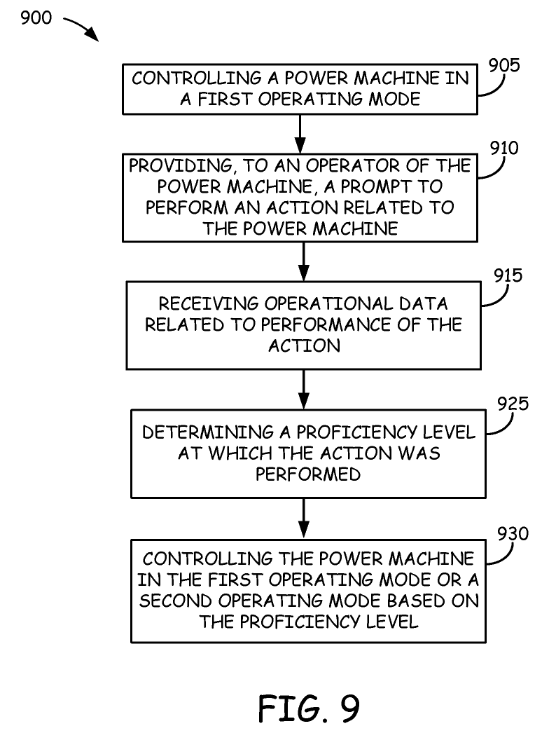

FIG. 9 is a flowchart illustrating a method 900 for implementing assessment functionality for a power machine (e.g., the power machine 600) according to some configurations. In some configurations, the method 900 can be performed by the control system 610 (e.g., the controller 690) and, in particular, by the electronic processor 700 of the controller 690 (e.g., by executing the training application 720). However, as noted above, the functionality described with respect to the method 900 may be performed by other devices or can be distributed among a plurality of devices or components (e.g., one or more electronic processors).

As illustrated in FIG. 9, the method 900 may include controlling, with the electronic processor 700, the power machine 600 in a first operating mode (at block 905). The first operating mode may provide limited power machine functionality. For example, the first operating mode may be an assessment or training mode (e.g., a lock-out mode) for the power machine 600.

While the power machine 600 is in the first operating mode, the electronic processor 700 may provide, to an operator of the power machine 600, a prompt to perform an action related to the power machine (at block 910). In some instances, the electronic processor 700 may provide the prompt based on information or data included in the training and assessment database 725 (e.g., a predetermined assessment or test). In some instances, the electronic processor 700 may provide sequential (e.g., consecutive) prompts to an operator of the power machine 600 in order to facilitate assessment of one or more capabilities of an operator, or a prompt that indicates multiple sequential (e.g., consecutive) actions to be performed by the operator.

While the electronic processor 700 provides the one or more prompts to the operator of the power machine 600, the sensor(s) 630 may collect operational data related to performance of the one or more actions performed by the operator in response to the one or more prompts (e.g., the sensor data 790). The electronic processor 700 may receive (or otherwise access) the operational data related to performance of the action(s) (at block 915).

As noted herein, in some instances, an assessment session may be implemented within a virtual environment where operator commands do not result in performance of the operator command within an actual work environment of the power machine 600. Rather, operator commands may be virtually represented within the virtual environment. In such instances, the operational data may be a prediction or estimation based on an operator command provided within the virtual environment. As one specific example, within the virtual environment, the operator may be prompted to adjust a tilt of a bucket of the power machine 600. The operator may respond to the prompt by adjusting a tilt of the bucket of the power machine 600. Following this example, the electronic processor 700 may estimate or predict operational data related to the operators commanded adjustment to the tilt of the bucket of the power machine 600. For instance, the electronic processor 700 may receive control signals from the operator input devices and determine, based on the control signals, whether the operator successfully adjusted the tilt of the bucket of the power machine 600.

The electronic processor 700 may determine a proficiency level at which the action(s) were performed based on the operational data (at block 925). In some instances, the electronic processor 700 may determine the proficiency level as a pass/fail (e.g., whether the operator performed the prompted action to the satisfaction of all relevant criteria, or not). The electronic processor 700 may determine the proficiency level using one or more criteria, thresholds, baselines, etc. (e.g., as included as part of the training and assessment data 730). For example, the electronic processor 700 may evaluate whether an operator implemented all required motions or other engagements with the power machine, or implemented particular action(s) according to relevant criteria. For example, particular action(s) of an operator under the method 900 can be evaluated based on whether implemented within a particular time (e.g., overall, or relative to intervals between successive actions), within a particular spatial area (e.g., deviating by less than a threshold percentage from a modeled movement), or otherwise.

The electronic processor 700 may control the power machine 600 in the first operating mode or the second operating mode based on the proficiency level (at block 930). When the proficiency level indicates a requisite understanding of the power machine 600, the electronic processor 700 may control the power machine 600 in a second operating mode. The second operating mode may provide additional power machine functionality relative to the first operating mode. For example, the second operating mode may be an unrestricted or normal operating mode. When the proficiency level indicates a lack of requisite understanding of the power machine 600 or otherwise inadequate proficiency, the electronic processor 700 may control the power machine 600 in the first operating mode (e.g., continue to control or maintain the power machine 600 in the first operating mode).

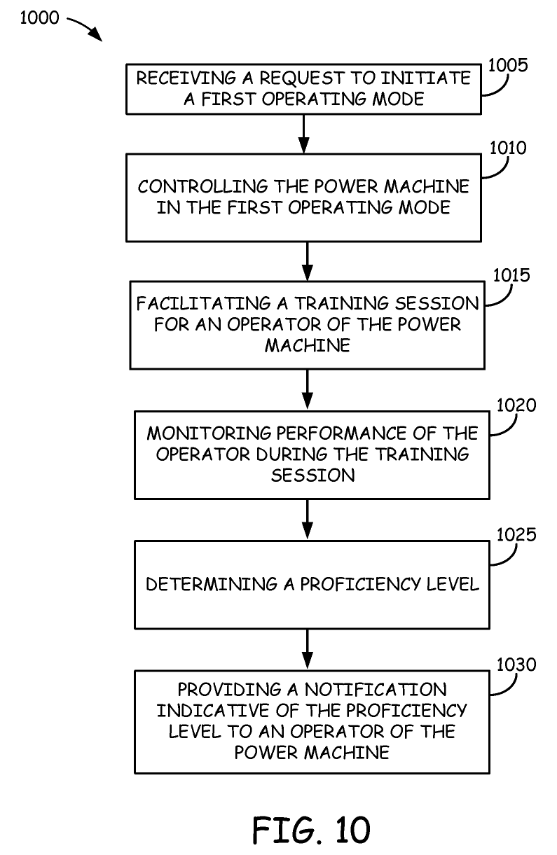

Alternatively, or in addition, in some instances, the technology disclosed herein may facilitate a training session for an operator of the power machine 600, as described in greater detail herein. For example, FIG. 10 is a flowchart illustrating a method 1000 for implementing training functionality for a power machine (e.g., the power machine 600) according to some configurations. In some configurations, the method 1000 can be performed by the control system 610 (e.g., the controller 690) and, in particular, by the electronic processor 700 of the controller 690 (e.g., by executing the training application 720). However, as noted above, the functionality described with respect to the method 1000 may be performed by other devices or can be distributed among a plurality of devices or components (e.g., one or more electronic processors).

In some configurations, the method 1000 may be performed automatically in response to an assessment of operator proficiency under the method 900 (see FIG. 9). For example, determination of a low proficiency level at block 925 may prompt automatic implementation of training for the relevant operator according to the method 1000. Further, in some configurations, the method 1000 may be performed on-demand – e.g., upon voice request, by or for an operator.

As illustrated in FIG. 10, the method 1000 may include receiving, with the electronic processor 700, a request to initiate a first operating mode (at block 1005). The first operating mode may be an operator-initiated training mode for the power machine, as described in greater detail herein. Responsive to the request, the electronic processor 700 may control the power machine 600 in the first operating mode (at block 1010). While the power machine 600 is in the first operating mode, the electronic processor 700 may facilitate a training session for an operator of the power machine 600 (at block 1015), as described in greater detail herein.

While the operator participates in the training session (e.g., performs one or more prompted actions in accordance with the training session), the operator’s performance may be monitored (e.g., by the sensor(s) 630) (at block 1020). In some cases, The electronic processor 700 may determine a proficiency level (or score) for the operator based on this monitoring of the operator’s performance (e.g., operational data collected during the training session, such as, e.g., the sensor data 790) (at block 1025). In some instances, the electronic processor 700 may provide (or otherwise output) a notification indicative of the proficiency level to an operator of the power machine (e.g., as a visual output via the display device 660, an audio output signal via the microphone 655, etc.). In some examples, achievement of a particular proficiency under the method 1000, or other completion of a training program, may be required before a user may implement further functionality (e.g., be re-assessed for proficiency under the method 900).

As noted herein, in some instances, a training session may be implemented within a virtual environment where operator commands do not result in performance of the operator command within an actual work environment of the power machine 600. Rather, the operator commands may be virtually represented within the virtual environment. In such instances, the operator’s performance may be monitored within the virtual environment. For example, operational data related to the operator’s performance may be a prediction or estimation based on the operator’s performance within the virtual environment (as opposed to, e.g., the sensor data 790).

In some configurations, the technology disclosed herein may be implemented to learn operator behavior. For instance, the technology disclosed herein may monitor an operator’s interaction with (or control of) the power machine 600 (e.g., using the sensor(s) 630) to learn an operator behavior or profile. The technology disclosed herein may analyze the operator behavior or profile in order to determine whether the operator behavior or profile may be improved, such as, e.g., by enabling a feature of the power machine 600, setting or adjusting an operational setting or parameter of the power machine 600, etc. When the technology disclosed herein determines that operation of the power machine 600 may be improved, the technology disclosed herein determine one or more recommendations (e.g., a feature to be enabled, an operational setting or parameter, etc.). In some instances, the technology disclosed herein may output the recommendation(s) to an operator of the power machine 600 (e.g., via the microphone 655, the display device 660, etc.). Responsive to an operator’s interaction with the recommendation(s) (e.g., the operator approving implementation of the recommendation(s)), the technology disclosed herein may implement the recommendation(s).

Alternatively, or in addition, in some cases, the recommendation may be automatically implemented without operator approval. For example, when implementation of the recommendation may result in improved preventative maintenance of the power machine 600, such as, e.g., an extended power machine life, a reduced downtime, a reduced risk of damage to the power machine 600, etc., the recommendation may be automatically implemented. In cases where the recommendation is automatically implemented, an operator may be notified of the automatic implementation of the recommendation (e.g., via the operator interface device(s) 635, such as the display device 660).

As one specific example, the technology disclosed herein may determine that an operator is regularly roading the power machine 600 above 5 mph during the course of a shift (and an on-board IMU (e.g., the sensor(s) 630) may detect substantial accelerations along a plane associated with bucket jerk). In such an instance, the technology disclosed herein may recommend that the operator enable automatic ride control or automatically enable automatic ride control in the background. As another specific example, the technology disclosed herein may determine that an operator is operating the power machine at a low/medium throttle and performing a work task, which may result in repeated engine draw-down conditions. In such an instance, the technology disclosed herein may detect such operation of the power machine 600 and recommend that the operator increase operating RPM or may automatically increase engine RPM in the background.

In some cases, the recommendation may relate to, e.g., an operating parameter or setting of the power machine 600, a feature of the power machine 600, a sequence of operations to be performed by the power machine 600, etc. Alternatively, or in addition, the recommendation may be a recommendation that the operator participate in a training session related to a particular learning objective or topic. For example, when the recommendation relates to implementing a ride control feature, the recommendation may suggest a training session related to how to implement and operate a ride control feature.

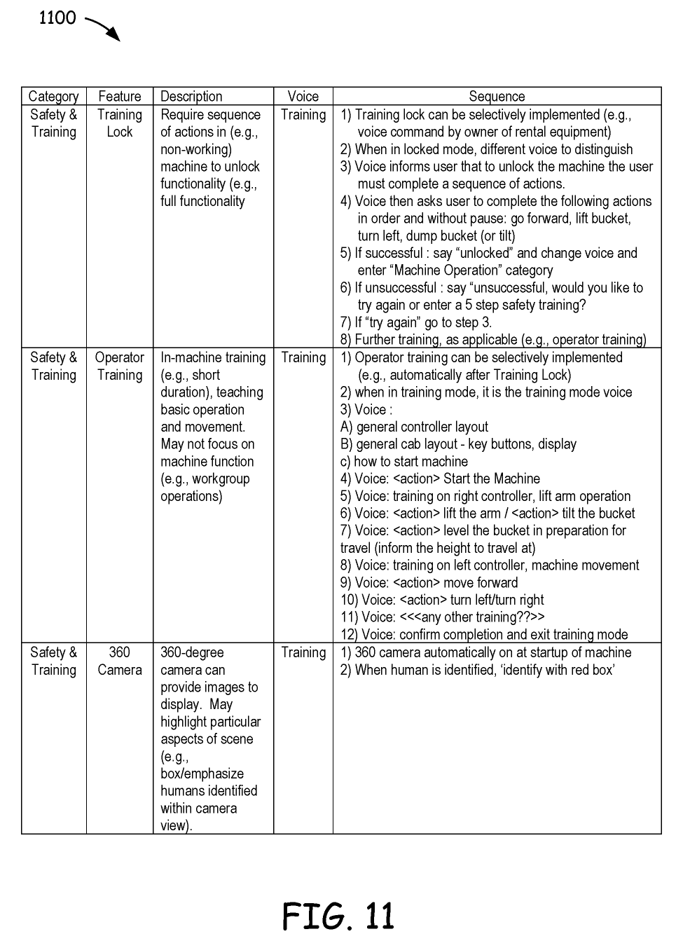

FIG. 11 illustrates a table 1100 that includes example features that may be implemented according to the disclosure herein (e.g., using voice-commands, as described in greater detail above). For instance, the table 1100 illustrates that implementation of a feature may involve various audio input signals (e.g., a sequence of audio input signals). In some examples, a training lock feature can be provided, as an implementation of the method 900 or other methods disclosed herein. Generally, a training lock feature may require an operator to demonstrate particular competence with particular operational engagement (e.g., command inputs at operator interface devices) to unlock particular (e.g., all) functionality of a power machine. As shown in FIG. 11, for example, a training-mode voice interaction can direct a user (e.g., a renter) to complete particular actions with particular timing (e.g., in order, without pause). If sufficient proficiency is determined in response to the user’s actions, further (e.g., all) functionality may be unlocked for the user (e.g., as also accompanied by a change in type of voice or other audio signal provided by the power machine).

As another example, operator training can be implemented to teach a user to perform particular operations (e.g., movements) with the power machine. In some cases, operator training can be automatically initiated in response to a determination of a low level of proficiency for a user during a training lock interaction. In some cases, operator training can be implemented on-demand, including by or for particular users (e.g., as directed by rental fleet managers, etc.). As shown in FIG. 11, for example, an operator training may include voice engagements (e.g., instructions) to guide an operator through layout, functionality, and particular sequences of commands (e.g., for particular movements, etc.).

As also shown in FIG. 11, in some examples, improved visual feedback can be provided to operators by including a large-field (e.g., 360-degree) camera. Such a camera, for example, can provide still or moving images to a display of the power machine for viewing and other interactions by a user. In some examples, a user can operate aspects of such a display or camera using voice-commands, as generally discussed above. In some examples, a system may highlight particular aspects of a displayed scene (e.g., adding a “box” or other visual highlight to emphasize identified humans, obstacles, or other scene features in a video display).

Unless otherwise specified or limited, the terms “about” and “approximately,” as used herein with respect to a reference value, refer to variations from the reference value of ± 15% or less, inclusive of the endpoints of the range. Similarly, the term “substantially,” as used herein with respect to a reference value, refers to variations from the reference value of ± 5% or less, inclusive of the endpoints of the range. Thus, for example, “substantially the same” and the like indicates values that are within ± 5% (inclusive) of each other.

Thus, examples of the disclosed systems and methods can provide for improved operation of sets of electric actuators for a power machine. For example, as further detailed above, cooperating sets of actuators can be controlled based on mixed or unified control schemes so that forces applied by the actuators are substantially balanced, with corresponding benefits for ease and efficiency of operation and for actuator health and lifespan.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the invention. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Although the present disclosure has been described with reference to preferred embodiments, workers skilled in the art will recognize that changes may be made in form and detail to the disclosed embodiments without departing from the spirit and scope of the concepts discussed herein.

What is claimed is:

1. A power machine comprising:
a power machine frame;
a plurality of actuators supported by the power machine frame, wherein the plurality of actuators includes a first actuator and a second actuator;
a lift arm structure that includes:
a lift arm coupled to the power machine frame and configured to be moved relative to the power machine frame by the first actuator; and
a work element supported by the lift arm and configured to be moved relative to the lift arm by the second actuator; and
a control system that includes one or more electronic processors in communication with the plurality of actuators, the one or more electronic processors configured to:
receive, using a microphone of the power machine, an audio input signal from an operator of the power machine, wherein the audio input signal is a query related to a machine status code of the power machine;
transform the audio input signal into a prompt;
retrieve data related to the prompt, the data including predetermined machine information specific to the machine status code of the power machine;
provide the data to a large language model (LLM), wherein the LLM generates a response to the query based on the prompt and the data; and
control the power machine to output the response to the operator of the power machine, wherein the response is responsive to the query.

2. The power machine of claim 1, wherein the machine status code is an active machine status code of the power machine while the audio input signal is received.

3. The power machine of claim 1, wherein the response includes at least one of:
a description of the machine status code;
a severity of the machine status code;
a remedial action to be performed in response to the machine status code; or
a part number for a component of the power machine causing the machine status code.

4. The power machine of claim 1, wherein the LLM is further configured to:
determine a cause of the machine status code, wherein the response indicates the cause of the machine status code.

5. The power machine of claim 4, wherein the LLM is further configured to:
determine the cause of the machine status code and a remedial action for the machine status code; and
predict a subsequent machine status code based on the cause of the machine status code and a potential failure to perform the remedial action, wherein the response indicates the subsequent machine status code.

6. The power machine of claim 4, wherein the LLM is configured to determine the cause of the machine status code based on sensor data related to operation of the power machine, wherein the sensor data is indicative of a trend with respect to operation of the power machine.

7. The power machine of claim 1, wherein the LLM is configured to:
determine a remedial action for the machine status code, wherein the remedial action is based on the predetermined machine information, and wherein the response indicates the remedial action.

8. The power machine of claim 7, wherein the remedial action is determined based on sensor data of the power machine that indicates a tendency to overwork a component of the power machine, and wherein the remedial action includes a modified operation of the component of the power machine.

9. The power machine of claim 7, wherein the remedial action includes replacement of a component of the power machine.

10. A power machine comprising:
a power machine frame;
a plurality of actuators supported by the power machine frame, wherein the plurality of actuators includes a first actuator and a second actuator;
a lift arm structure that includes:
a lift arm coupled to the power machine frame and configured to be moved relative to the power machine frame by the first actuator; and
a work element supported by the lift arm and configured to be moved relative to the lift arm by the second actuator; and
a control system that includes one or more electronic processors in communication with the plurality of actuators, the one or more electronic processors configured to:
receive, using a microphone of the power machine, an audio input signal from an operator of the power machine, the audio input signal representing a query relating to maintenance of the power machine;
transform the audio input signal into a prompt;
retrieve data related to the prompt, wherein the data includes machine information;
provide the retrieved data to a large language model (LLM), wherein the LLM is to generate a response to the query based on the prompt and the retrieved data; and
control the power machine to output the response to the operator of the power machine, responsive to the query.

11. The power machine of claim 10, wherein the retrieved data includes predetermined machine information specific to the power machine.

12. The power machine of claim 10, wherein the query is related to an error code or a service code of the power machine that is presently being provided to the operator of the power machine.

13. The power machine of claim 10, wherein the query that is a question related to a maintenance schedule of the power machine, and wherein the machine information relates to the maintenance schedule of the power machine.

14. The power machine of claim 10, wherein the one or more electronic processors are configured to:
determine a recommendation based on the retrieved data and the query, wherein the response to the query includes the recommendation.

15. The power machine of claim 14, wherein the recommendation includes at least one of:
a remedial action for a machine status code presently being provided to the operator of the power machine;
a modified operation of a component of the power machine;
a training program or resource for the operator of the power machine; or
a replacement component for the power machine.

16. A power machine comprising:
a power machine frame;
a plurality of actuators supported by the power machine frame, wherein the plurality of actuators includes a first actuator and a second actuator;
a lift arm structure that includes:
a lift arm coupled to the power machine frame and configured to be moved relative to the power machine frame by the first actuator; and
a work element supported by the lift arm and configured to be moved relative to the lift arm by the second actuator; and
a control system that includes one or more electronic processors in communication with the plurality of actuators, the one or more electronic processors configured to:
receive, using a microphone of the power machine, an audio input signal from an operator of the power machine, the audio input signal to include a user query relating to the power machine;
transform the audio input signal into a prompt;
retrieve data related to the prompt;
provide the retrieved data to a large language model (LLM), wherein the LLM generates a response to the user query based on the prompt and the retrieved data; and
control the power machine to output the response to the operator of the power machine.

17. The power machine of claim 16, wherein the user query is related to at least one of:
a machine status code presently being provided to the operator of the power machine;
a maintenance schedule specific to the power machine;
sensor data related to operation of the power machine;
a static attribute of the power machine;
a feature of the power machine; or
a component of the power machine.

18. The power machine of claim 16, wherein the one or more electronic processors retrieve the data from a database stored locally at the power machine, and wherein the LLM is local to the power machine.

19. The power machine of claim 16, wherein the one or more electronic processors are configured to:
retrieve the retrieved data related to the prompt from at least one of:
a sensor of the power machine, wherein the retrieved data includes an operational parameter of the power machine; or
a database that stores predetermined machine information, wherein the retrieved data includes a portion of the predetermined machine information.

20. The power machine of claim 1, wherein the one or more electronic processors are to:
generate an audio output signal representative of the response; and
control the power machine to output the audio output signal via a speaker of the power machine.
